(19) United States
(12) Patent Application Publication
(10) Pub. No.: US 2024/0228301 A1
(43) Pub. Date: Jul. 11, 2024

(54) PROCESS FOR PREPARING PHOSGENE

(71) Applicant: BASF SE, Ludwigshafen am Rhein (GB)

(72) Inventors: Gerhard OLBERT, Ludwigshafen am Rhein (GB); Koenraad VANDEWALLE, Antwerp (BE); Torsten MATTKE, Ludwigshafen am Rhein (GB); Jens FERBITZ, Ludwigshafen am Rhein (GB); Kai THIELE, Antwerp (BE); Peter VAN DEN ABEEL, Antwerp (BE); Jim BRANDTS, De Meern (NL)

(21) Appl. No.: 18/287,481

(22) PCT Filed: Mar. 14, 2022
(86) PCT No.: PCT/EP2022/056537

§ 371 Date: Oct. 19, 2023

(30) Foreign Application Priority Data
Apr. 21, 2021 (EP) 21169642.2

(51) Int. Cl. C01B 32/80; B01J 8/06; B01J 21/18; B01J 35/64

(52) U.S. Cl. CPC C01B 32/80; B01J 8/065; B01J 21/18; B01J 35/643; B01J 35/647

(57) ABSTRACT

The present invention relates to a continuous process for preparing phosgene as well as a production unit for carrying out said process.

The present invention relates to a continuous process for preparing phosgene as well as a production unit for carrying out said process.

Phosgene is a widely used reagent for technical carbonylations, namely in the production of acid chlorides and isocyanates. Phosgene is primarily produced from carbon monoxide and chlorine in a gas phase catalysis, usually over an activated carbon catalyst. Because of the exothermic reaction, the synthesis is carried out in cooled reactors, preferably in tube bundle reactors, the catalyst being filled in the reaction tubes and the cooling in the jacket space being effected by a liquid or boiling coolant medium.

Phosgene is produced in large-scale in a catalytic gas phase reaction of carbon monoxide and chlorine in the presence of a catalyst, for example, an activated carbon catalyst, according to the reaction equation

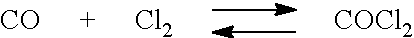

The reaction is strongly exothermic with a reaction enthalpy ΔH of −107.6 KJ/mol. To remove the reaction heat the reaction is normally carried out in tube-bundle reactors with catalyst filled in-side the tubes (see Ullmann's Encyclopedia of industrial chemistry, Chapter, Phosgene” 5^{th} Ed. Vol. A 19, p 413 ff., VCH Verlagsgesellschaft mbH, Weinheim, 1991). Generally, granular catalyst with a grain size in the range of from 3 to 5 mm is used in pipes with a typical inner diameter between 35 and 70 mm, typically between 39 and 45 mm. In the reaction, carbon monoxide is usually used in excess to ensure that all chlorine is converted, and largely chlorine-free phosgene is produced, since chlorine can lead to undesirable side reactions in the subsequent use of phosgene. The reaction can be carried out without pressure but is usually carried out at an overpressure of 200-600 kPa (2-6 bar). In this pressure range, the formed phosgene can be condensed after the reactor with cooling water or other heat carrier, for example organic heat carrier can be used, so that the condenser can be operated more economically.

Usually, the reaction starts at temperatures of 40 to 50° C., but the high reaction rate in connection with the high exothermicity lead to the formation of a hot spot which is well above 450° C., and often above 500° C. as mentioned by Christopher J. Mitchell et al., Selection of carbon catalysts for the industrial manufacture of phosgene, Hunstman Polyurethanes, Catal. Sci. Technol., 2012, 2109-2115. These locally high temperatures lead to the deactivation/burn-off of the catalyst, for example by chlorination of the carbon to carbon tetrachloride over the length of the reaction tube in the presence of chlorine in the gas stream. At such high temperatures, the chlorine acts aggressively on the activated carbon catalyst. The higher the temperature is, the higher CCl₄ is formed, which is then also noticeable in a loss of carbon and stronger chlorination (stronger chemical bond). Furthermore, the removal of the considerable reaction heat requires a corresponding number of individual tubes in the reactor. In addition, the high thermal loads in a chlorine-containing atmosphere can cause corrosive attack on the pipe wall material. This requires more noble and therefore more expensive pipe wall materials as well as an intensive heat transfer on the coolant side.

Overall, the deactivation requires regular catalyst replacement and therefore shutdown of the production plant. The investment in the reactors is high due to the number of tubes and higher quality materials. Thus, heat management within the reactor is one of the main challenges in phosgene production necessary for performing a safe and economic process.

Therefore, it was an object of the present invention to provide an improved process for preparing phosgene. In particular, it was necessary to provide a new process for the preparation of phosgene which presents a high productivity in particular by increasing the lifetime and efficiency of the catalyst. Surprisingly, it was found that the process for preparing phosgene according to the present invention presents high productivity and reduces the need to shutdown the production plants for replacing the catalyst.

Therefore, the present invention relates to a continuous process for preparing phosgene, comprising
(i) providing a gas stream G1 comprising carbon monoxide (CO) and chlorine (Cl₂);
(ii) passing the gas stream G1 into a reaction zone Z1, bringing the gas stream G1 into contact with a catalyst C1 comprised in said reaction zone Z1, obtaining a gas stream GP comprising phosgene and one or more of carbon monoxide and chlorine, and removing the gas stream GP from said reaction zone Z1;
(iii) dividing the gas stream GP, obtaining at least two gas streams comprising a gas stream G2 and a gas stream GR, G2 and GR having the same chemical composition as GP, wherein the ratio of the mass flow f(GR) of the gas stream GR relative to the mass flow f(G2) of the gas stream G2, f(GR):f(G2), is in the range of from 0.1:1 to 20:1;
   wherein during standard operation mode of the continuous process, providing the gas stream G1 according to (i) comprises
   preparing G1 as a mixture comprising at least two gas streams, said at least two gas streams comprising the gas stream GR and j gas streams G0(k) with k=1, . . . j, wherein the j gas streams G0(k) in total comprise carbon monoxide (CO) and chlorine (Cl₂) and wherein j is in the range of from 1 to 3.

Preferably j is 1 or 2, more preferably 2.

Preferably the mixture consists of the at least two gas streams as defined in the foregoing.

As to f(GR):f(G2) ratio, it is preferred that it is in the range of from 0.2:1 to 10:1, more preferably in the range of from 0.25:1 to 4:1, more preferably in the range of from 0.3:1 to 3:1. It is more preferred that f(GR):f(G2) is in the range of from 0.3:1 to 1.5:1. Said ratio can also preferably be in the range of from 0.5:1 to 1.5:1. Alternatively, it is preferred that f(GR):f(G2) is in the range of from 5:1 to 8:1.

When using an adiabatic reactor, it is preferred that f(GR):f(G2) is in the range of from 5:1 to 8:1. When using a cooled reactor, it is preferred that f(GR):f(G2) is in the range of from 0.3:1 to 1.5:1.

It is preferred that the mole ratio of the amount of chlorine, in mol, to the amount of carbon monoxide, in mol, in the j gas streams G0(k) in total is in the range of from 0.6:1 to 0.999:1, more preferably in the range of from 0.7:1 to 0.98, more preferably in the range of from 0.85:1 to 0.95:1.

During standard operation mode of the continuous process, it is preferred that providing the gas stream G1 according to (i) comprises

preparing G1 as a mixture comprising, more preferably consisting of, three gas streams, said three gas streams being the gas stream GR and two gas streams G0(1) and G0(2), wherein the two gas streams G0(1) and G0(2) in total comprise carbon monoxide (CO) and chlorine (Cl₂).

During standard operation mode of the continuous process, it is preferred that providing the gas stream G1 according to (i) comprises

preparing G1 according to (i) as a mixture comprising, more preferably consisting of, three gas streams GR, G0(1) and G0(2), G0(1) comprising carbon monoxide (CO) and G0(2) comprises chlorine (Cl₂), comprises
combining the gas stream G0(1) with the gas stream G0(2), more preferably in a static mixer, and
admixing the gas stream GR with the combined gas streams G0(1) and G0(2).

It is preferred that admixing the gas stream GR with the combined two gas streams G0(1) and G0(2) according to (i) is performed in a mixing device, wherein the mixing device is an ejector, a static mixer or a dynamic mixer, more preferably an ejector, wherein the ejector is more preferably driven by the combined gas streams G0(1) and G0(2).

It is preferred that the combined gas streams G0(1) and G0(2) has a pressure P0 and the gas stream GR has a pressure PR, wherein P0>PR, wherein more preferably the gas stream G1 has a pressure P1 and P0>P1>PR. It is preferred that the pressure P0 ranges from 2 to 20 bar(abs), more preferably from 4 to 10 bar(abs).

It is preferred that the mole ratio of the amount of chlorine, in mol, to the amount of carbon monoxide, in mol, in the combined gas streams G0(1) and G0(2) is in the range of from 0.6:1 to 0.999:1, more preferably in the range of from 0.7:1 to 0.98, more preferably in the range of from 0.85:1 to 0.95:1.

In the context of the present invention, it is preferred that the recycle ratio is the ratio of the mass flow f(GR) of the gas stream GR relative to the mass flow f(GP) of the gas stream GP, f(GR):f(GP), which is in the range of from 0.2:1 to 0.95:1. It is more preferred that the recycle ratio is the ratio of the mass flow f(GR) of the gas stream GR relative to the mass flow f(GP) of the gas stream GP, f(GR):f(GP), which is in the range of from 0.25:1 to 0.8:1, more preferably in the range of from 0.3:1 to 0.7:1, more preferably in the range of from 0.35:1 to 0.6:1. It is alternatively more preferred that the recycle ratio is the ratio of the mass flow f(GR) of the gas stream GR relative to the mass flow f(GP) of the gas stream GP, f(GR):f(GP), which is in the range of from 0.50:1 to 0.92:1, more preferably in the range of from 0.70:1 to 0.90:1. The latter ratio being particularly preferred when the reaction zone Z1 preferably comprises an uncooled reactor as defined in the following.

It is preferred that the gas stream G1 has a temperature T(G1) in the range of from 20 to 200° C., more preferably in the range of from 50 to 90° C., more preferably in the range of from 70 to 80° C.

Preferably the gas stream G0(k) has a temperature T(G0(k)) in the range of from 25 to 60° C., more preferably in the range of from 30 to 40° C.

It is more preferred that the gas stream G0(1) has a temperature T(G0(1)) in the range of from 25 to 60° C., more preferably in the range of from 30 to 40° C. and the gas stream G0(2) has a temperature T(G0(2)) in the range of from 25 to 60° C., more preferably in the range of from 30 to 40° C.

During standard operation mode of the continuous process, it is preferred that providing the gas stream G1 according to (i) comprises

preparing G1 according to (i) as a mixture comprising, more preferably consisting of, three gas streams GR, G0(1) and G0(2), G0(1) comprising carbon monoxide (CO) and G0(2) comprises chlorine (Cl₂), comprises
admixing the gas stream G0(1) with the gas stream GR, and
combining, more preferably in a static mixer, the gas stream G0(2) with the admixed gas streams G0(1) and GR.

It is preferred that admixing the gas stream G0(1) with the gas stream GR according to (i) is performed in a mixing device, wherein the mixing device is an ejector, a static mixer or a dynamic mixer, more preferably an ejector, wherein the ejector is more preferably driven by the gas stream G0(1).

Preferably the gas stream G0(1) has a pressure P0(1) and the gas stream GR has a pressure PR, wherein P0(1)>PR. It is preferred that the pressure PO ranges from 2 to 20 bar(abs), more preferably from 4 to 10 bar(abs).

During standard operation mode of the continuous process, it is preferred that providing the gas stream G1 according to (i) comprises

preparing G1 according to (i) as a mixture comprising, more preferably consisting of, three gas streams GR, G0(1) and G0(2), G0(1) comprising carbon monoxide (CO) and G0(2) comprises chlorine (Cl₂), comprises
admixing the gas stream G0(2) with the gas stream GR, and
combining, more preferably in a static mixer, the gas stream G0(1) with the admixed gas streams G0(2) and GR.

It is preferred that admixing the gas stream G0(2) with the gas stream GR according to (i) is performed in a mixing device, wherein the mixing device is an ejector, a static mixer or a dynamic mixer, more preferably an ejector, wherein the ejector is more preferably driven by the gas stream G0(2).

It is preferred that the gas stream G0(2) has a pressure P0(2) and the gas stream GR has a pressure PR, wherein P0(2)>PR. It is more preferred that the pressure P0 ranges from 2 to 20 bar(abs), more preferably from 4 to 10 bar(abs).

Preferably from 99 to 100 weight-%, more preferably from 99.5 to 100 weight-%, more preferably from 99.9 to 100 weight-%, of the gas stream G0(1) consists of carbon monoxide. In other words, it is preferred that the gas stream G0(1) consists essentially of, more preferably consists of, carbon monoxide.

Preferably from 99 to 100 weight-%, more preferably from 99.5 to 100 weight-%, more preferably from 99.9 to 100 weight-%, of the gas stream G0(2) consists of chlorine. In other words, it is preferred that the gas stream G0(2) consists essentially of, more preferably consists of, chlorine.

In the context of the present invention, it is preferred that the reaction zone Z1 comprises a re- actor comprising the catalyst C1.

Preferably the reactor is a tubular reactor comprising one or more tubes, the catalyst C1 being filled in said one or more tubes.

Preferably the gas stream in the reactor is of at most 450° C., more preferably at most 400° C., more preferably at most 350° C., the temperature being more preferably measured with a multipoint thermocouple. More preferably said temperature is controlled for example by fixing the recycle ratio defined in the foregoing and/or by varying the temperature of the gas stream G1. Indeed, it is preferred that the amount and the temperature of the recycle gas, namely gas stream GR, are selected to control the temperature of the reaction zone and the outlet temperature of the reaction zone.

It is preferred that the reactor is a cooled reactor, more preferably a cooled tube-bundle reactor. Preferably the cooled reactor comprises a coolant medium.

It is preferred that the coolant medium more preferably having a temperature ranging from 50 to 300° C., more preferably in the range of from 50 to 270° C., more preferably ranging from 60 to 100° C., more preferably ranging from 70 to 90° C.

It is preferred that the coolant medium is selected from the group consisting of monochlorobenzene and water, more preferably is monochlorobenzene.

It is preferred that the cooled reactor comprises one or more cooling zones, more preferably comprises one zone or two cooling zones. When the cooled reactor comprises one cooling zone, it is preferred that the coolant medium has a temperature in the range of from 50 to 270° C., more preferably ranging from 60 to 100° C., more preferably ranging from 70 to 90° C.

When the cooled reactor preferably comprises one cooling zone, it is preferred that said cooling zone comprises an inlet means for introducing the coolant medium in cooling tubes and an outlet means for recovering the coolant medium. Such configuration is shown on FIGS. 2a, 2b, 3 and 5.

When the cooled reactor preferably comprises two cooling zones, a first cooling zone and a second cooling zone, it is preferred that the first cooling zone comprises a first inlet means for introducing a first coolant medium in cooling tubes and a first outlet means for recovering the first coolant medium and that the second cooling zone comprises a second inlet means for introducing a second coolant medium in cooling tubes and a second outlet means for recovering the second coolant medium. Such configuration is shown on FIG. 6. It is more preferred that the first coolant medium and the second coolant medium be the same coolant medium. It is believed that this configuration with two zones will permit to save the heat generation which took place in the reaction zone Z1 for production of high worthy steam. The first cooling zone can be for example running at a temperature range of from 200 to 300° C., preferably of about 250° C. It is preferred that with a heat transfer oil passing in the first cooling zone, the heat produced from the reaction of the catalyst C1 in a reactor of the reaction zone Z1 could then be removed from the reactor of the reaction zone Z1. The oil recovered from the first cooling zone can thus serve to heat a solvent in a other heat exchanger (outside of the production unit for preparing phosgene). The second cooling zone can be running under normal conditions, namely at about 80° C. A reactor with more than one cooling zone can be such as described in WO 03/072237 A1.

When using a cooled reactor, it is preferred that the recycle ratio is the ratio of the mass flow f(GR) of the gas stream GR relative to the mass flow f(GP) of the gas stream GP, f(GR):f(GP), which is in the range of from 0.2:1 to 0.95:1. It is more preferred that the recycle ratio is the ratio of the mass flow f(GR) of the gas stream GR relative to the mass flow f(GP) of the gas stream GP, f(GR):f(GP), which is in the range of from 0.25:1 to 0.8:1.

Alternatively, it is preferred that the reactor is an uncooled reactor, more preferably an adiabatic fixed-bed reactor.

When using an adiabatic reactor, it is preferred that the recycle ratio is the ratio of the mass flow f(GR) of the gas stream GR relative to the mass flow f(GP) of the gas stream GP, f(GR):f(GP), which is in the range of from 0.50:1 to 0.92:1, more preferably in the range of from 0.70:1 to 0.90:1.

When using an adiabatic reactor, it is preferred that, prior to preparing G1 as a mixture comprising, more preferably consisting of, at least two streams according to (i) during standard operation mode of the continuous process, said process further comprises cooling the gas stream GR, more preferably with a heat exchanger.

When using an adiabatic reactor, it is preferred that (ii) further comprises passing the gas stream GP into a cooling means comprised in the reaction zone Z1 prior to removing from said reaction zone Z1, wherein the cooling means more preferably is one or more cooling tubes.

In the context of the present invention, it is preferred that the process further comprises, after (iii), passing the gas stream GR through a return means R prior to preparing G1 as a mixture comprising, more preferably consisting of, at least two streams according to (i), during standard operation mode of the continuous process, in an ejector.

It is preferred that the return means R forms a loop external to the reactor, for recycling GR and admixing it with G0(k) according to (i), during standard operation mode of the continuous process. It is also conceivable that the return means R be preferably internal to the reactor as illustrated on FIG. 4.

As to the catalyst C1, there is no particular restrictions as long as said catalyst permits to obtain phosgene, preferably it is a carbon catalyst or carbon-based catalyst—both terms being equally interchangeable. Any catalysts for preparing phosgene known in the art can be used as catalyst C1, such as commercially available activated carbons from companies like Donau Carbon (Desorex, Supersorbon), Cabot (e.g. Norit RB4C), Chemviron.

It is preferred that the catalyst C1 is activated carbon from Donau Carbon.

It is alternatively preferred that the catalyst C1 comprises, preferably is, a porous material comprising carbon, micropores and mesopores, wherein said micropores have a pore diameter of less than 2 nm and wherein said mesopores have a pore diameter in the range of from 2 to 50 nm,

wherein the volume of the mesopores of the porous material is of at least 0.45 ml/g. It is more preferred that the micropore volume be determined according to DIN 66135-2, that the mesopore volume be determined according to DIN 66134 and that the volume of the mesopores of the porous material be determined according to dual-isotherm Nonlocal Density Functional Theoretical (NLDFT) Advanced Pore Size Distribution (PSD) technique.

Preferably the ratio of the volume of the mesopores of the porous material relative to the volume of the micropores of the porous material is of at least 1:1, more preferably in the range of from 1.1:1 to 6:1, more preferably in the range of from 1.15:1 to 5:1, more preferably in the range of from 1.2:1 to 4:1. It is preferred that the volume of the mesopores of the porous material and the volume of the micropores of the porous material be determined according to dual-isotherm NLDFT Advanced PSD technique.

Preferably the ratio of the volume of the mesopores of the porous material relative to the total pore volume of the porous material, is of at least 0.5:1, more preferably in the range of from 0.5:1 to 0.9:1, more preferably in the range of from 0.55:1 to 0.85:1, more preferably in the range of from 0.6:1 to 0.8:1, more preferably in the range of from 0.65:1 to 0.8:1. It is preferred that the volume of the mesopores of the porous material and the total pore volume of the porous material be determined according to dual-isotherm NLDFT Advanced PSD technique.

Preferably the volume of the mesopores of the porous material is of at least 0.5 ml/g.

As to the total pore volume of the porous material, it is preferred that it is in the range of from 0.5 to 2.25 ml/g, more preferably in the range of from 0.55 to 1.75 ml/g, more preferably in the range of from 0.65 to 1.70 ml/g. It is preferred that the total pore volume of the porous material be determined according to dual-isotherm NLDFT Advanced PSD technique.

Preferably less than or equal to 40%, more preferably less than or equal to 30%, more prefer- ably less than or equal to 25%, more preferably less than or equal to 20%, more preferably less than or equal to 15%, more preferably less than or equal to 10%, more preferably less than or equal to 5%, more preferably less than or equal to 2.5%, more preferably less than or equal to 1%, of the total pore volume of the porous material resides in mesopores having a pore diameter of greater than 20 nm.

It is preferred that the volume of the mesopores of the porous material is in the range of from 0.50 to 0.54 ml/g, more preferably in the range of from 0.51 to 0.53 m/g, and that the ratio of the volume of the mesopores of the porous material relative to the total pore volume of the porous material is in the range of from 0.70:1 to 0.75:1, more preferably in the range of from 0.72:1 to 0.74:1. It is preferred that the volume of the mesopores of the porous material and the total pore volume of the porous material be determined according to dual-isotherm NLDFT Advanced PSD technique.

It is alternatively preferred that the volume of the mesopores of the porous material is in the range of from 0.64 to 0.70 ml/g, more preferably in the range of from 0.65 to 0.67 ml/g, and that the ratio of the volume of the mesopores of the porous material relative to the total pore volume of the porous material, is in the range of from 0.72:1 to 0.78:1, more preferably in the range of from 0.73:1 to 0.76:1. It is preferred that the volume of the mesopores of the porous material and the total pore volume of the porous material be determined according to dual-isotherm NLDFT Advanced PSD technique.

Preferably the volume of the micropores of the porous material, more preferably determined according to dual-isotherm NLDFT Advanced PSD technique, is of at most 0.7 ml/g, more preferably of at most 0.6 ml/g.

As to the BET specific surface area of the porous material, it is preferred that it is of at least 500 m²/g, more preferably in the range of from 500 to 2500 m²/g, more preferably in the range of from 550 to 1800 m²/g, more preferably in the range of from 600 to 1500 m²/g.

Preferably the total specific surface area of the porous material, measured according to dualisotherm NLDFT Advanced PSD technique, is of at least 600 m²/g, more preferably in the range of from 650 to 2000 m²/g, more preferably in the range of from 700 to 1800 m²/g.

Preferably the specific surface area of the porous material induced by the mesopores, measured according to dual-isotherm NLDFT Advanced PSD technique, is of in the range of from 70 to 250 m²/g, more preferably in the range of from 80 to 170 m²/g.

Preferably the ratio of specific surface area of the porous material induced by the mesopores relative to the total specific surface area of the porous material is in the range of from 0.07:1 to 0.40:1, more preferably in the range of from 0.07:1 to 0.20:1.

It is preferred that the porous material be a pyrolyzed carbon aerogel.

It is preferred that the porous material be an activated pyrolyzed carbon aerogel.

Preferably from 99 to 100 weight-%, more preferably from 99.5 to 100 weight-%, more preferably from 99.9 to 100 weight-%, of the porous material consists of the carbon.

Preferably less than or equal to 0.5 weight-% of the porous material consists of oxygen.

Preferably less than or equal to 0.5 weight-%, more preferably less than or equal to 0.1 weight-%, of the porous material consists of hydrogen.

Preferably less than or equal to 0.01 weight-% of the porous material consists of nitrogen.

Preferably the ash content of the porous material is of less than or equal to 0.1 weight-%, more preferably less than or equal to 0.08 weight-%, more preferably less than or equal to 0.05 weight-%, more preferably less than or equal to 0.03 weight-%, more preferably less than or equal to 0.025 weight-%, more preferably less than or equal to 0.01 weight-%, more preferably less than or equal to 0.0075 weight-%, more preferably less than or equal to 0.005 weight-%, more preferably less than or equal to 0.001 weight-%, based on the weight of said porous material, as calculated from total reflection x-ray fluorescence data.

Preferably the porous material has a total impurity content of elements having atomic numbers ranging from 11 to 92 as measured by total reflection x-ray fluorescence (TXRF) of less than 500 ppm, more preferably less than 300 ppm, more preferably less than 200 ppm, more preferably less than 100 ppm.

Preferably from 50 to 98 weight-%, more preferably from 60 to 95 weight-%, of the gas stream GP consist of phosgene.

It is preferred that by dividing the gas stream GP according to (iii), two gas streams are obtained, the gas stream G2 and the gas stream GR.

It is preferred that the process further comprises
(iv) passing the stream G2 into a reaction zone Z2, bringing the gas stream G2 into contact with a catalyst C2 comprised in said reaction zone Z2, obtaining a gas stream GF comprising phosgene, and removing the gas stream GF from said reaction zone Z2.

Preferably the reaction zone Z2 comprises a reactor comprising the catalyst C2, more preferably a tubular reactor comprising one or more tubes, the catalyst C2 being filled in said one or more tubes.

Preferably the reactor is a cooled reactor, preferably a cooled tube-bundle reactor. Alternatively, it is preferred that the reactor is an adiabatic fixed bed reactor.

Preferably the cooled reactor comprises a coolant medium, the coolant medium more preferably having a temperature ranging from 50 to 270° C., more preferably ranging from 60 to 100° C., more preferably ranging from 70 to 90° C. It is preferred that the coolant medium is selected from the group consisting of monochlorobenzene and water, more preferably is monochlorobenzene.

As to the catalyst C2, no particular restriction exists as long as it permits to obtain phosgene. Any catalyst know in the art for preparing phosgene can be used in the present invention as catalyst C2. It is preferred that it comprises carbon. It is preferred that the catalyst C2 has the same chemical and physical composition as the catalyst C1. Alternatively, it is preferred that the catalyst C2 has different chemical and/or physical composition to the catalyst C1. It is more preferred that the catalyst C2 has the same chemical and physical composition as the catalyst C1.

Preferably the concentration of phosgene in the gas stream GF is higher than the concentration of phosgene in the gas stream GP.

Preferably at most 500 weight-ppm, more preferably from 0 to 300 weight-ppm, more preferably from 0 to 100 weight-ppm, of the gas stream GF consist of chlorine.

It is preferred that the process further comprises
(v) condensing phosgene of the gas stream GF obtained in (iv). In the context of the present invention, it is also preferred that multistep condensation are per-formed in the process of the present invention, more preferably accompanied to adsorption or distillation step.

It is preferred that, after (iv) or (v), no recycling of CO is operated. It is however also conceivable that CO recycling is operated.

The present invention further relates to a production unit for carrying out the process according to the present invention, the unit comprising
a reaction zone Z1 comprising
   an inlet means for passing the gas stream G1 into Z1;
   a catalyst C1;
   a reaction means for bringing into contact the gas stream G1 with said catalyst C1;
   an outlet means for removing the gas stream GP from Z1;
a stream dividing device S for dividing the gas stream GP in at least two streams, preferably two streams, comprising a gas stream GR and a gas stream G2;
a means for passing the gas stream GP into said device S;
at least one, preferably two, means M for preparing G1 as a mixture comprising at least two streams;
a return means R for passing the gas stream GR exiting from S to said means M for preparing G1.

Preferably the mixture consists of the at least two streams.

Preferably the reaction means of the reaction zone Z1 is a reactor.

It is preferred that the reactor of the reaction zone Z1 be a tubular reactor comprising one or more tubes, more preferably a tube-bundle reactor.

Preferably the tubular reactor comprises one or more tubes and the catalyst C1 is comprised in said one or more tubes.

Preferably the tubular reactor comprises from 1 to 10000 tubes, more preferably from 1000 to 9000 tubes.

Preferably the tubes of the tubular reactor have a length in the range of from 1.5 to 12 m, more preferably in the range of from 1.8 to 10 m, more preferably in the range of from 1.9 to 5 m.

Preferably the one or more tubes, more preferably the tubes, of the tubular reactor have an inner diameter in the range of from 20 to 90 mm, more preferably in the range of from 30 to 60 mm, more preferably in the range of from 35 to 50 mm.

Preferably the one or more tubes, more preferably the tubes, of the tubular reactor have a wall thickness in the range of from 2.0 to 4.0 mm, preferably in the range of from 2.5 to 3.0 mm.

Preferably the one or more tubes, more preferably the tubes, of the tubular reactor are made of corrosion-resistant material, preferably of iron-based alloys, nickel-based alloys or nickel, more preferably of duplex steel 1.4462, stainless steel 1.4571, or stainless steel 1.4541.

Preferably the reaction means of the reaction zone Z1 is cooled, more preferably with one or more of water and mono-chlorobenzene, more preferably with mono-chlorobenzene.

It is preferred that the reaction means of the reaction zone Z1 be a cooled tube-bundle reactor. Preferably the cooled reactor comprises one or more cooling zones, more preferably comprises one zone or two cooling zones.

It is preferred that the cooled reactor comprises one or more cooling zones, more preferably comprises one zone or two cooling zones. When the cooled reactor comprises one cooling zone, it is preferred that the coolant medium has a temperature in the range of from 50 to 270 ° C., more preferably ranging from 60 to 100° C., more preferably ranging from 70 to 90° C.

When the cooled reactor preferably comprises one cooling zone, it is preferred that said cooling zone comprises an inlet means for introducing the coolant medium in cooling tubes and an outlet means for recovering the coolant medium. Such configuration is shown on FIGS. 2a, 2b, 3 and 5.

When the cooled reactor preferably comprises two cooling zones, a first cooling zone and a second cooling zone, it is preferred that the first cooling zone comprises a first inlet means for introducing a first coolant medium in cooling tubes and a first outlet means for recovering the first coolant medium and that the second cooling zone comprises a second inlet means for introducing a second coolant medium in cooling tubes and a second outlet means for recovering the second coolant medium. Such configuration is shown on FIG. 6. It is more preferred that the first coolant medium and the second coolant medium be the same coolant medium. It is believed that this configuration with two zones will permit to save the heat generation which took place in the reaction zone Z1 for production of high worthy steam. The first cooling zone can be for example running at a temperature range of from 200 to 300° C., preferably of about 250° C. It is preferred that with a heat transfer oil passing in the first cooling zone, the heat produced from the reaction of the catalyst C1 in a reactor of the reaction zone Z1 could then be removed from the reactor of the reaction zone Z1. The oil recovered from the first cooling zone can thus serve to heat a solvent in a other heat exchanger (outside of the production unit for preparing phosgene). The second cooling zone can be running under normal conditions, namely at about 80° C. A reactor with more than one cooling zone can be such as described in WO 03/072237 A1.

It is alternatively preferred that the reaction means of the reaction zone Z1 is an uncooled reaction means and the reaction zone Z1 further comprises a cooling means downstream of the reaction means.

Preferably, when the reaction means of the reaction zone Z1 is an uncooled reaction means, the return means R further comprises the cooling means.

Preferably the uncooled reaction means is an adiabatic fixed-bed reactor.

In the context of the present invention, it is preferred that the return means R is a return pipe, more preferably an external return pipe to the reactor of Z1 or an internal return pipe to the reactor of Z1, more preferably an external return pipe.

In this regard, it is noted that the inner diameter of the return pipe will in general depend on the capacity. Preferably the return pipe has an inner diameter in the range of from 100 to 500 mm, more preferably in the range of from 150 to 300 mm.

Preferably the return pipe is made of corrosion-resistant material, more preferably of iron-based alloys, nickel-based alloys or nickel, more preferably of duplex steel 1.4462, stainless steel 1.4571, or stainless steel 1.4541.

Preferably the unit comprises two means M for preparing G1 as a mixture comprising, more preferably consisting of, at least two streams. A means M(e) which is preferably an ejector for admixing GR and a gas stream G0(k) and a means M(s) which is preferably a static mixer.

Preferably the means M(s) is upstream of the means M(e), the means M(s) being a static mixer for combining G0(1) and G0(2) and the means M(e) being an ejector for admixing GR and the combined gas streams G0(1) and G0(2).

Preferably, as an alternative, the means M(e) is upstream of the means M(s), the means M(e) being an ejector for admixing GR and G0(1) or G0(2) and the means M(s) being a static mixer for combining the other of G0(1) and G0(2) with the admixed gas streams G0(1) or G0(2).

It is preferred that the production unit further comprises
a reaction zone Z2 comprising
   an inlet means for passing the gas stream G2 into Z2;
   a catalyst C2;
   a reaction means for bringing into contact the gas stream G1 with said catalyst C2;
   an outlet means for removing the gas stream GF from Z2.

Preferably the reaction means of the reaction zone Z2 is a reactor.

It is preferred that the reactor of the reaction zone Z2 be a tubular reactor comprising one or more tubes, more preferably a tube-bundle reactor. The reactor used in the present invention can be any cooled reactor known by the skilled person in the art, for example the reactor can be as described in WO 03/072237 A1.

Preferably the tubular reactor comprises one or more tubes and the catalyst C2 is comprised in the one or more tubes.

Preferably the tubular reactor comprises from 1 to 10000 tubes, more preferably from 1000 to 9000 tubes.

Preferably the one or more tubes, more preferably the tubes, of the tubular reactor have a length in the range of from 1.5 to 12 m, more preferably in the range of from 1.8 to 10 m, more preferably in the range of from 1.9 to 5 m.

Preferably the one or more tubes, more preferably the tubes, of the tubular reactor have an inner diameter in the range of from 20 to 90 mm, more preferably in the range of from 30 to 60 mm, more preferably in the range of from 35 to 50 mm.

Preferably the one or more tubes, more preferably the tubes, of the tubular reactor have a wall thickness in the range of from 2.0 to 4.0 mm, more preferably in the range of from 2.5 to 3.0 mm.

Preferably the one or more tubes, more preferably the tubes, of the tubular reactor are made of corrosion-resistant material, more preferably of iron-based alloys, nickel-based alloys or nickel, more preferably of duplex steel 1.4462, stainless steel 1.4571, or stainless steel 1.4541.

Preferably the reaction means of the reaction zone Z2 is cooled with a coolant medium, wherein the coolant medium is one or more of water and mono-chlorobenzene, more preferably is mono-chlorobenzene.

Preferably the reaction means of the reaction zone Z2 is a cooled tube-bundle reactor.

Preferably, as an alternative, the reaction means of the reaction zone Z2 is an adiabatic fixedbed reactor.

In the context of the present invention, it is preferred that the surface loading of phosgene obtained by the production unit is in the range of from of 0.5 to 6 kg/m²s, more preferably in the range of 0.7 to 5 kg/m²s, more preferably in the range of 0.7 to 4 kg/m²s, more preferably in the range of 0.8 to 3.5 kg/m²s.

It is preferred that the production unit further comprises a means for condensing phosgene of the gas stream GF.

The present invention further relates to a use of the production unit according to the present invention for the continuous production of phosgene.

For sake of completeness, in the context of the present invention, it is noted that since the gas stream GR, G2 and GP have the same chemical composition, it excludes by itself the use of a condenser downstream of the reaction zone, preferably the reactor, such that it is excluded that the gas stream GR is passed through a condenser prior to preparing G1 and that the gas stream GP is passed through a condenser prior to dividing according to (iii).

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments represents a suitably structured part of the general description directed to preferred aspects of the present invention, and, thus, suitably supports, but does not represent the claims of the present invention.
1. A continuous process for preparing phosgene, comprising
   (i) providing a gas stream G1 comprising carbon monoxide (CO) and chlorine (Cl₂);
   (ii) passing the gas stream G1 into a reaction zone Z1, bringing the gas stream G1 into contact with a catalyst C1 comprised in said reaction zone Z1, obtaining a gas stream GP comprising phosgene and one or more of carbon monoxide and chlorine, and removing the gas stream GP from said reaction zone Z1;
   (iii) dividing the gas stream GP, obtaining at least two gas streams comprising a gas stream G2 and a gas stream GR, G2 and GR having the same chemical composition as GP, wherein the ratio of the mass flow f(GR) of the gas stream GR relative to the mass flow f(G2) of the gas stream G2, f(GR):f(G2), is in the range of from 0.1:1 to 20:1;
wherein during standard operation mode of the continuous process, providing the gas stream G1 according to (i) comprises
preparing G1 as a mixture comprising at least two gas streams, said at least two gas streams comprising the gas stream GR and j gas streams G0(k) with k=1, . . . j, wherein the j gas streams G0(k) in total comprise carbon monoxide (CO) and chlorine (Cl₂) and wherein j is in the range of from 1 to 3.
2. The process of embodiment 1, wherein j is 1 or 2, preferably 2.
3. The process of embodiment 1 or 2, wherein f(GR):f(G2) is in the range of from 0.2:1 to 10:1, preferably in the range of from 0.25:1 to 4:1, more preferably in the range of from 0.3:1 to 3:1, more preferably in the range of from 0.3:1 to 1.5:1 or preferably in the range of from 5:1 to 8:1.
4. The process of any one of embodiments 1 to 3, wherein the mole ratio of the amount of chlorine, in mol, to the amount of carbon monoxide, in mol, in the j gas streams G0(k) in total is in the range of from 0.6:1 to 0.999:1, preferably in the range of from 0.7:1 to 0.98, more preferably in the range of from 0.85:1 to 0.95:1.
5. The process of any one of embodiments 1 to 4, wherein during standard operation mode of the continuous process, providing the gas stream G1 according to (i) comprises preparing G1 as a mixture comprising, preferably consisting of, three gas streams, said three gas streams being the gas stream GR and two gas streams G0(1) and G0(2), wherein the two gas streams G0(1) and G0(2) in total comprise carbon monoxide (CO) and chlorine (Cl₂).
6. The process of any one of embodiments 1 to 5, wherein during standard operation mode of the continuous process, providing the gas stream G1 according to (i) comprises preparing G1, as a mixture comprising, preferably consisting of, three gas streams GR, G0(1) and G0(2), G0(1) comprising carbon monoxide (CO) and G0(2) comprises chlorine (Cl₂), which comprises
   combining the gas stream G0(1) with the gas stream G0(2), preferably in a static mixers, and
   admixing the gas stream GR with the combined gas streams G0(1) and G0(2).
7. The process of embodiment 6, wherein admixing the gas stream GR with the combined two gas streams G0(1) and G0(2) according to (i) is performed in a mixing device, wherein the mixing device is an ejector, a static mixer or a dynamic mixer, preferably an ejector, wherein the ejector is more preferably driven by the combined gas streams G0(1) and G0(2).
8. The process of embodiment 6 or 7, wherein the combined gas streams G0(1) and G0(2) has a pressure P0 and the gas stream GR has a pressure PR, wherein P0>PR, wherein preferably the gas stream G1 has a pressure P1 and P0>P1>PR; wherein more preferably the pressure P0 ranges from 2 to 20 bar(abs), preferably from 4 to 10 bar(abs).
9. The process of any one of embodiments 6 to 8, wherein the mole ratio of the amount of chlorine, in mol, to the amount of carbon monoxide, in mol, in the combined gas streams G0(1) and G0(2) is in the range of from 0.6:1 to 0.999:1, preferably in the range of from 0.7:1 to 0.98, more preferably in the range of from 0.85:1 to 0.95:1.
10. The process of any one of embodiments 1 to 9, wherein the recycle ratio is the ratio of the mass flow f(GR) of the gas stream GR relative to the mass flow f(GP) of the gas stream GP, f(GR):f(GP), which is in the range of from 0.2:1 to 0.95:1, preferably in the range of from 0.25:1 to 0.8:1, more preferably in the range of from 0.3:1 to 0.7:1, more preferably in the range of from 0.35:1 to 0.6:1.
11. The process of any one of embodiments 1 to 10, wherein the gas stream G1 has a temperature T(G1) in the range of from 20 to 200° C., preferably in the range of from 50 to 90° C., more preferably in the range of from 70 to 80° C.
12. The process of any one of embodiments 1 to 11, wherein the gas stream G0(k) has a temperature T(G0(k)) in the range of from 25 to 60° C., preferably in the range of from 30 to 40° C.,
wherein preferably, as far as embodiment 12 depends on embodiment 6, the gas stream G0(1) has a temperature T(G0(1)) in the range of from 25 to 60° C., more preferably in the range of from 30 to 40° C. and the gas stream G0(2) has a temperature T(G0(2)) in the range of from 25 to 60° C., more preferably in the range of from 30 to 40° C.
13. The process of any one of embodiments 1 to 5, wherein during standard operation mode of the continuous process, providing the gas stream G1 according to (i) comprises preparing G1, as a mixture comprising, more preferably consisting of, three gas streams GR, G0(1) and G0(2), G0(1) comprising carbon monoxide (CO) and G0(2) comprises chlorine (Cl₂), which comprises
   admixing the gas stream G0(1) with the gas stream GR, and
   combining, preferably in a static mixer, the gas stream G0(2) with the admixed gas streams G0(1) and GR.
14. The process of embodiment 13, wherein admixing the gas stream G0(1) with the gas stream GR according to (i) is performed in a mixing device, wherein the mixing device is an ejector, a static mixer or a dynamic mixer, preferably an ejector, wherein the ejector is more preferably driven by the gas stream G0(1).
15. The process of embodiment 13 or 14, wherein the gas stream G0(1) has a pressure P0(1) and the gas stream GR has a pressure PR, wherein P0(1)>PR; wherein more preferably the pressure P0 ranges from 2 to 20 bar(abs), preferably from 4 to 10 bar(abs).
16. The process of any one of embodiments 1 to 5, wherein during standard operation mode of the continuous process, providing the gas stream G1 according to (i) comprises preparing G1, as a mixture comprising, preferably consisting of, three gas streams GR, G0(1) and G0(2), G0(1) comprising carbon monoxide (CO) and G0(2) comprises chlorine (Cl₂), which comprises
   admixing the gas stream G0(2) with the gas stream GR, and
   combining, preferably in a static mixer, the gas stream G0(1) with the admixed gas streams G0(2) and GR.
17. The process of embodiment 16, wherein admixing the gas stream G0(2) with the gas stream GR according to (i) is performed in a mixing device, wherein the mixing device is an ejector, a static mixer or a dynamic mixer, preferably an ejector, wherein the ejector is more preferably driven by the gas stream G0(2).
18. The process of embodiment 16 or 17, wherein the gas stream G0(2) has a pressure P0(2) and the gas stream GR has a pressure PR, wherein P0(2)>PR; wherein more preferably the pressure P0 ranges from 2 to 20 bar(abs), preferably from 4 to 10 bar(abs).
19. The process of any one of embodiments 5 to 18, wherein from 99 to 100 weight-%, preferably from 99.5 to 100 weight-%, more preferably from 99.9 to 100 weight-%, of the gas stream G0(1) consists of carbon monoxide.
20. The process of any one of embodiments 5 to 19, wherein from 99 to 100 weight-%, preferably from 99.5 to 100 weight-%, more preferably from 99.9 to 100 weight-%, of the gas stream G0(2) consists of chlorine.
21. The process of any one of embodiments 1 to 20, wherein the reaction zone Z1 comprises a reactor comprising the catalyst C1.
22. The process of embodiment 21, wherein the reactor is a tubular reactor comprising one or more tubes, the catalyst C1 being filled in said one or more tubes.
23. The process of embodiment 22, wherein the gas stream in the reactor is of at most 450° C., preferably at most 400° C., more preferably at most 350° C., the temperature being preferably measured with a multipoint thermocouple.
24. The process of embodiment 22 or 23, wherein the reactor is a cooled reactor, preferably a cooled tube-bundle reactor.
25. The process of any one of embodiments 22 to 24, wherein the reactor comprises a cool-ant medium, the coolant medium preferably having a temperature ranging from 50 to 270° C., more preferably ranging from 60 to 100° C., more preferably ranging from 70 to 90° C., wherein the coolant medium preferably is selected from the group consisting of monochlorobenzene and water, more preferably monochlorobenzene.
26. The process of embodiment 21, wherein the reactor is an uncooled reactor, preferably an adiabatic fixed-bed reactor.
27. The process of embodiment 26, wherein, prior to preparing G1 as a mixture comprising, preferably consisting of, at least two streams according to (i) during standard operation mode of the continuous process, said process further comprises cooling the gas stream GR, preferably with a heat exchanger.
28. The process of embodiment 26, wherein (ii) further comprises passing the gas stream GP into a cooling means comprised in the reaction zone Z1 prior to removing from said reaction zone Z1, wherein the cooling means preferably is one or more cooling tubes.
29. The process of any one of embodiments 1 to 28, further comprising, after (iii), passing the gas stream GR through a return means R prior to preparing G1 as a mixture comprising, preferably consisting of, at least two streams according to (i), during standard operation mode of the continuous process, in an ejector.
30. The process of embodiment 29, as far as it depends on any one of embodiments 22 to 28, wherein the return means R forms a loop external to the reactor, for recycling GR and admixing it with G0(k) according to (i), during standard operation mode of the continuous process.
31. The process of any one of embodiments 1 to 30, wherein the catalyst C1 comprises, preferably is, a porous material comprising carbon, micropores and mesopores, wherein said micropores have a pore diameter, preferably determined according to DIN 66135-2, of less than 2 nm and wherein said mesopores have a pore diameter, preferably determined ac-cording to DIN 66134, in the range of from 2 to 50 nm,
wherein the volume of the mesopores of the porous material, preferably determined according to dual-isotherm Nonlocal Density Functional Theoretical (NLDFT) Advanced Pore Size Distribution (PSD) technique, is of at least 0.45 ml/g.
32. The process of embodiment 31, wherein the ratio of the volume of the mesopores of the porous material relative to the volume of the micropores of the porous material is of at least 1:1, preferably in the range of from 1.1:1 to 6:1, more preferably in the range of from 1.15:1 to 5:1, more preferably in the range of from 1.2:1 to 4:1, the volume of the mesopores of the porous material and the volume of the micropores of the porous material being preferably determined according to dual-isotherm NLDFT Advanced PSD technique.
33. The process of embodiment 31 or 32, wherein the ratio of the volume of the mesopores of the porous material relative to the total pore volume of the porous material, is of at least 0.5:1, preferably in the range of from 0.5:1 to 0.9:1, more preferably in the range of from 0.55:1 to 0.85:1, more preferably in the range of from 0.6:1 to 0.8:1, more preferably in the range of from 0.65:1 to 0.8:1, the volume of the mesopores of the porous material and the total pore volume of the porous material being preferably determined according to dual-isotherm NLDFT Advanced PSD technique.
34. The process of any one of embodiments 31 to 33, wherein the volume of the mesopores of the porous material is of at least 0.5 ml/g.
35. The process of any one of embodiments 31 to 34, wherein the total pore volume of the porous material is in the range of from 0.5 to 2.25 ml/g, preferably in the range of from 0.55 to 1.75 ml/g, more preferably in the range of from 0.65 to 1.70 ml/g, the total pore volume of the porous material being preferably determined according to dual-isotherm NLDFT Advanced PSD technique.
36. The process of any one of embodiments 31 to 35, wherein less than or equal to 40%, preferably less than or equal to 30%, more preferably less than or equal to 25%, more preferably less than or equal to 20%, more preferably less than or equal to 15%, more preferably less than or equal to 10%, more preferably less than or equal to 5%, more preferably less than or equal to 2.5%, more preferably less than or equal to 1%, of the total pore volume of the porous material resides in mesopores having a pore diameter of greater than 20 nm.
37. The process of any one of embodiments 31 to 36, wherein the volume of the mesopores of the porous material is in the range of from 0.50 to 0.54 ml/g, preferably in the range of from 0.51 to 0.53 m/g, and the ratio of the volume of the mesopores of the porous material relative to the total pore volume of the porous material is in the range of from 0.70:1 to 0.75:1, preferably in the range of from 0.72:1 to 0.74:1, the volume of the mesopores of the porous material and the total pore volume of the porous material being preferably determined according to dual-isotherm NLDFT Advanced PSD technique.
38. The process of any one of embodiments 31 to 36, wherein the volume of the mesopores of the porous material is in the range of from 0.64 to 0.70 ml/g, preferably in the range of from 0.65 to 0.67 ml/g, and the ratio of the volume of the mesopores of the porous material relative to the total pore volume of the porous material, is in the range of from 0.72:1 to 0.78:1, preferably in the range of from 0.73:1 to 0.76:1, the volume of the mesopores of the porous material and the total pore volume of the porous material being preferably determined according to dual-isotherm NLDFT Advanced PSD technique.
39. The process of any one of embodiments 31 to 38, wherein the volume of the micropores of the porous material, preferably determined according to dual-isotherm NLDFT Advanced PSD technique, is of at most 0.7 ml/g, preferably of at most 0.6 ml/g.
40. The process of any one of embodiments 31 to 39, wherein the BET specific surface area of the porous material is of at least 500 m²/g, preferably in the range of from 500 to 2500 m²/g, more preferably in the range of from 550 to 1800 m²/g, more preferably in the range of from 600 to 1500 m²/g.
41. The process of any one of embodiments 31 to 40, wherein the total specific surface area of the porous material, measured according to dual-isotherm NLDFT Advanced PSD technique, is of at least 600 m²/g, preferably in the range of from 650 to 2000 m²/g, more preferably in the range of from 700 to 1800 m²/g.
42. The process of any one of embodiments 31 to 41, wherein the specific surface area of the porous material induced by the mesopores, measured according to dual-isotherm NLDFT Advanced PSD technique, is of in the range of from 70 to 250 m²/g, preferably in the range of from 80 to 170 m²/g.
43. The process of embodiment 42, wherein the ratio of specific surface area of the porous material induced by the mesopores relative to the total specific surface area of the porous material is in the range of from 0.07:1 to 0.40:1, preferably in the range of from 0.07:1 to 0.20:1.
44. The process of any one of embodiments 31 to 43, wherein the porous material is a pyrolyzed carbon aerogel, preferably an activated pyrolyzed carbon aerogel.
45. The process of any one of embodiments 31 to 44, wherein from 99 to 100 weight-%, preferably from 99.5 to 100 weight-%, more preferably from 99.9 to 100 weight-%, of the porous material consists of the carbon.
46. The process of any one of embodiments 31 to 45, wherein less than or equal to 0.5 weight-% of the porous material consists of oxygen.
47. The process of any one of embodiments 31 to 46, wherein less than or equal to 0.5 weight-%, preferably less than or equal to 0.1 weight-%, of the porous material consists of hydrogen.
48. The process of any one of embodiments 1 to 17, wherein less than or equal to 0.01 weight-%, of the porous material consists of nitrogen.
49. The process of any one of embodiments 1 to 18, wherein the ash content of the porous material is of less than or equal to 0.1 weight-%, preferably less than or equal to 0.08 weight-%, more preferably less than or equal to 0.05 weight-%, more preferably less than or equal to 0.03 weight-%, more preferably less than or equal to 0.025 weight-%, more preferably less than or equal to 0.01 weight-%, more preferably less than or equal to 0.0075 weight-%, more preferably less than or equal to 0.005 weight-%, more preferably less than or equal to 0.001 weight-%, based on the weight of said porous material, as calculated from total reflection x-ray fluorescence data.
50. The process of any one of embodiments 1 to 19, wherein the porous material has a total impurity content of elements having atomic numbers ranging from 11 to 92 as measured by total reflection x-ray fluorescence (TXRF) of less than 500 ppm, preferably less than 300 ppm, more preferably less than 200 ppm, more preferably less than 100 ppm.
51. The process of any one of embodiments 1 to 50, wherein from 50 to 98 weight-%, preferably from 60 to 95 weight-%, of the gas stream GP consist of phosgene.
52. The process of any one of embodiments 1 to 51, wherein by dividing the gas stream GP according to (iii), two gas streams are obtained, the gas stream G2 and the gas stream GR.
53. The process of any one of embodiments 1 to 52, further comprising (iv) passing the stream G2 into a reaction zone Z2, bringing the gas stream G2 into contact with a catalyst C2 comprised in said reaction zone Z2, obtaining a gas stream GF comprising phosgene, and removing the gas stream GF from said reaction zone Z2.
54. The process of embodiment 53, wherein the reaction zone Z2 comprises a reactor comprising the catalyst C2, preferably a tubular reactor comprising one or more tubes, the catalyst C2 being filled in said one or more tubes.
55. The process of embodiment 54, wherein the reactor is a cooled reactor, preferably a cooled tube-bundle reactor, or the reactor is an uncooled reactor, preferably an adiabatic fixed-bed reactor.
56. The process of embodiment 55, wherein the cooled reactor comprises a coolant medium, the coolant medium preferably having a temperature ranging from 50 to 270° C., more preferably ranging from 60 to 100° C., more preferably ranging from 70 to 90° C., wherein the coolant medium preferably is selected from the group consisting of monochlorobenzene and water, more preferably monochlorobenzene.
57. The process of any one of embodiments 53 to 56, wherein the catalyst C2 comprises carbon, wherein preferably the catalyst C2 has the same chemical and physical composition of the catalyst C1 or preferably the catalyst C2 has different chemical and/or physical composition of the catalyst C1, more preferably the catalyst C2 has the same chemical and physical composition as the catalyst C1.
58. The process of any one of embodiments 53 to 57, wherein the concentration of phosgene in the gas stream GF is higher than the concentration of phosgene in the gas stream GP.
59. The process of any one of embodiments 53 to 58, wherein at most 500 weight-ppm, preferably from 0 to 300 weight-ppm, more preferably from 0 to 100 weight-ppm, of the gas stream GF consist of chlorine.
60. The process of any one of embodiments 1 to 59, further comprising (v) condensing phosgene of the gas stream GF obtained in (iv).
61. The process of any one of embodiments 1 to 60, wherein after (iv) or (v) no recycling of CO is operated.
62. A production unit for carrying out the process according to any one of embodiments 1 to 61, the unit comprising
   a reaction zone Z1 comprising
      an inlet means for passing the gas stream G1 into Z1;
      a catalyst C1;
      a reaction means for bringing into contact the gas stream G1 with said catalyst C1;
      an outlet means for removing the gas stream GP from Z1;
   a stream dividing device S for dividing the gas stream GP in at least two streams, preferably two streams, comprising a gas stream GR and a gas stream G2;
   a means for passing the gas stream GP into said device S;
   at least one, preferably two, means M for preparing G1 as a mixture comprising, preferably consisting of, at least two streams;
   a return means R for passing the gas stream GR exiting from S to said means M for preparing G1.
63. The production unit of embodiment 62, wherein the reaction means of the reaction zone Z1 is a reactor, preferably a tubular reactor comprising one or more tubes, more preferably a tube-bundle reactor.
64. The production unit of embodiment 63, wherein the tubular reactor comprises one or more tubes and the catalyst C1 is comprised in said one or more tubes.
65. The production unit of embodiment 63 or 64, wherein the tubular reactor comprises from 1 to 10000 tubes, preferably from 1000 to 9000 tubes.
66. The production unit of any one of embodiments 63 to 65, wherein the tubes of the tubular reactor have a length in the range of from 1.5 to 12 m, preferably in the range of from 1.8 to 10 m, more preferably in the range of from 1.9 to 5 m.
67. The production unit of any one of embodiments 63 to 66, wherein the one or more tubes, preferably the tubes, of the tubular reactor have an inner diameter in the range of from 20 to 90 mm, preferably in the range of from 30 to 60 mm, more preferably in the range of from 35 to 50 mm.
68. The production unit of any one of embodiments 63 to 67, wherein the one or more tubes, preferably the tubes, of the tubular reactor have a wall thickness in the range of from 2.0 to 4.0 mm, preferably in the range of from 2.5 to 3.0 mm.
69. The production unit of any one of embodiments 63 to 68, wherein the one or more tubes, preferably the tubes, of the tubular reactor are made of corrosion-resistant material, preferably of iron-based alloys, nickel-based alloys or nickel, more preferably of duplex steel 1.4462, stainless steel 1.4571, or stainless steel 1.4541.
70. The production unit of any one of embodiments 62 to 69, wherein the reaction means of the reaction zone Z1 is cooled, preferably with one or more of water and monochlorobenzene, more preferably with mono-chlorobenzene, wherein the reaction means of the reaction zone Z1 is a cooled tube-bundle reactor.
71. The production unit of embodiment 70, wherein the cooled reactor comprises one or more cooling zones, more preferably comprises one zone or two cooling zones.
72. The production unit of embodiment 62, wherein the reaction means of the reaction zone Z1 is an uncooled reaction means and the reaction zone Z1 further comprises a cooling means downstream of the reaction means.
73. The production unit of embodiment 72, wherein the return means R further comprises the cooling means.
74. The process of embodiment 72 or 73, wherein the uncooled reaction means is an adiabatic fixed-bed reactor.
75. The production unit of any one of embodiments 62 to 74, wherein the return means R is a return pipe, preferably an external return pipe to the reactor of Z1 or an internal return pipe to the reactor of Z1, more preferably an external return pipe.
76. The production unit of embodiment 75, wherein the return pipe has an inner diameter in the range of from 100 to 500 mm, preferably in the range of from 150 to 300 mm.
77. The production unit of embodiment 75 or 76, wherein the return pipe is made of corrosion-resistant material, preferably of iron-based alloys, nickel-based alloys or nickel, more preferably of duplex steel 1.4462, stainless steel 1.4571, or stainless steel 1.4541.
78. The production unit of any one of embodiments 62 to 77, wherein the unit comprises two means M for preparing G1 as a mixture comprising, preferably consisting of, at least two streams, a means M(e) being an ejector for admixing GR and a gas stream G0(k) and a means M(s) being a static mixer.
79. The production unit of embodiment 78, wherein the means M(s) is upstream of the means M(e), the means M(s) being a static mixer for combining G0(1) and G0(2) and the means M(e) being an ejector for admixing GR and the combined G0(1) and G0(2).
80. The production unit of embodiment 78, wherein the means M(e) is upstream of the means M(s), the means M(e) being an ejector for admixing GR and G0(1) or G0(2) and the means M(s) being a static mixer for combining the other of G0(1) and G0(2) with the admixed G0(1) or G0(2).
81. The production unit of any one of embodiments 62 to 80, further comprises
   a reaction zone Z2 comprising
      an inlet means for passing the gas stream G2 into Z2;
      a catalyst C2;
      a reaction means for bringing into contact the gas stream G1 with said catalyst C2;
      an outlet means for removing the gas stream GF from Z2.
82. The production unit of embodiment 81, wherein the reaction means of the reaction zone Z2 is a reactor, preferably a tubular reactor comprising one or more tubes, more preferably a tube-bundle reactor.
83. The production unit of embodiment 82, wherein the tubular reactor comprises one or more tubes and the catalyst C2 is comprised in the one or more tubes.
84. The production unit of embodiment 82 or 83, wherein the tubular reactor comprises from 1 to 10000 tubes, preferably from 1000 to 9000 tubes.
85. The production unit of any one of embodiments 82 to 84, wherein the one or more tubes, preferably the tubes, of the tubular reactor have a length in the range of from 1.5 to 12 m, preferably in the range of from 1.8 to 10 m, more preferably in the range of from 1.9 to 5m.
86. The production unit of any one of embodiments 82 to 85, wherein the one or more tubes, preferably the tubes, of the tubular reactor have an inner diameter in the range of from 20 to 90 mm, preferably in the range of from 30 to 60 mm, more preferably in the range of from 35 to 50 mm.
87. The production unit of any one of embodiments 82 to 86, wherein the one or more tubes, preferably the tubes, of the tubular reactor have a wall thickness in the range of from 2.0 to 4.0 mm, preferably in the range of from 2.5 to 3.0 mm.
88. The production unit of any one of embodiments 82 to 87, wherein the one or more tubes, preferably the tubes, of the tubular reactor are made of corrosion-resistant material, preferably of iron-based alloys, nickel-based alloys or nickel, more preferably of duplex steel 1.4462, stainless steel 1.4571, or stainless steel 1.4541.
89. The production unit of any one of embodiments 81 to 88, wherein the reaction means of the reaction zone Z2 is cooled with a coolant medium, wherein the coolant medium is one or more of water and mono-chlorobenzene, more preferably mono-chlorobenzene, wherein the reaction means of the reaction zone Z2 is a cooled tube-bundle reactor.
90. The production unit of any one of embodiments 81 to 89, wherein the surface loading of phosgene obtained by the production unit is in the range of from of 0.5 to 6 kg/m²s, preferably in the range of 0.7 to 5 kg/m²s, more preferably in the range of 0.7 to 4 kg/m²s, more preferably in the range of 0.8 to 3.5 kg/m²s.
91. The production unit of any one of embodiments 81 to 90, further comprising a means for condensing phosgene of the gas stream GF.
92. Use of the production unit according to any one of embodiments 62 to 91 or of a process according to any one of embodiments 1 to 61 for the continuous production of phosgene.

In the context of the present invention, a term “one or more of A, B and C”, it is meant to disclose A, or B, or C, or A and B, or A and C, or B and C, or A and B and C. In this regard, it is noted that the skilled person is capable of transfer to above abstract term to a concrete example, e.g. A, B and C are concrete elements such as Li, Na, and K. In this regard, it is further noted that the skilled person is capable of extending the above term to less specific realizations of said feature, e.g. “one or more of A and B” disclosing A, or B, or A and B.

In the context of the present invention, the terms “total pore volume of the porous material” and “total pore volume” refer to the sum of the volume of the mesopores of the porous material and the volume of the micropores of the porous material.

In the context of the present invention, the total pore volume of the porous material is the sum of the volume of the mesopores of the porous material and the volume of the micropores of the porous material.

In the context of the present invention, the total specific surface area of the porous material is preferably determined by dual-isotherm NLDFT Advanced Pore Size Distribution (Micromeretics ASAP 2020_Micromeritics Instrument Corp., Norcross, GA, USA). NLDFT Surface area is expressed in m²/g. The NLDFT Advanced Pore Size Distribution technique employs up to two inert gases, namely nitrogen and carbon dioxide, to measure the amount of gas adsorbed on a material and can be used to determine the accessible surface area of a given material.

Further, in the context of the present invention, the total pore volume of the porous material is preferably determined by dual-isotherm NLDFT Advanced Pore Size Distribution (Micromeretics ASAP 2020_Micromeretics Instrument Corp., Norcross, GA, USA). Said total pore volume is expressed in ml/g. The NLDFT Advanced Pore Size Distribution technique employs up to two inert gases, namely nitrogen and carbon dioxide, to measure the amount of gas adsorbed on a given material and can be used to determine the total pore volume of said given material. Similarly, the pore volume within certain pore size ranges (mesopores, micropores) is determined by the same method. Hence, the volume of the mesopores of the porous material and the volume of the micropores of the porous material are determined by dual-isotherm NLDFT Advanced Pore Size Distribution (Micromeretics ASAP 2020).

In the context of the present invention, the term “BET specific surface area” refers to the total specific surface area of a material, such as the porous material, measurable by the BET technique. The BET specific surface area is expressed in m²/g. For example, the BET specific surface area can be determined by BET (Brunauer/Emmett/Teller) method by physical adsorption of nitrogen at −196° C.(liquid nitrogen) using a Micrometrics ASAP 2420 apparatus.

In the context of the present invention, it is noted that the multipoint thermocouple used for measuring temperature of a given gas in the reaction tube(s) was of the type described in DE 10110847 A1.

The present invention is further illustrated be the following examples 1 to 5 and FIGS. 2 to 6.

### EXAMPLES

The multipoint thermocouple(s) used in the following is/are as described in DE 10110847 A1.

### Reference Example 1: Production of a Catalyst Comprising Carbon

The catalysts (porous carbon materials) 5 and 7 were prepared by a process defined in WO 2012/092210 A1: one approach for producing such high surface area activated carbon materials is to prepare a synthetic polymer from carbon-containing organic building blocks (e.g., a polymer gel). For example, varying the polymerizing and gelation conditions (temperature, duration, etc.) permits to obtain different catalysts. As with the existing organic materials, the synthetically prepared polymers are dried (e.g., by evaporation or freeze drying) pyrolyzed and activated to produce an activated carbon material (e.g., an aerogel or xerogel). Thus, the method for preparing the catalysts 4 to 7, a porous material (pyrolyzed carbon aerogel) comprising carbon, micropores and mesopores, comprises:
preparing a mixture comprising a solvent (water/acetic acid), a catalyst (ammonium acetate catalyst), a first monomer (resorcinol) and a second monomer (formaldehyde);
co-polymerize the first and second monomer of the mixture, obtaining a resin mixture;
curing the obtained resin mixture at a curing temperature (e.g. 95° C.), obtaining a polymer composition comprising the solvent and a polymer formed from co-polymerizing the first and second monomer, wherein the solvent concentration in the polymer composition is at least 40 weight-%, based on the total weight of the polymer composition; and
pyrolyzing the obtained polymer composition at a pyrolysis temperature thereby substantially removing the solvent and pyrolyzing the polymer to yield a carbon material. Alternatively, the process comprises
preparing a mixture comprising a solvent (water/acetic acid), a catalyst (ammonium acetate catalyst), a first monomer (resorcinol) and a second monomer (formaldehyde), and maintaining the reaction mixture at a reaction temperature for a reaction time;
co-polymerize the first and second monomer of the obtained mixture, obtaining a resin mixture; curing the obtained resin mixture at a curing temperature (e.g. 95° C.), obtaining a polymer composition comprising the solvent and a polymer formed from co-polymerizing the first and second monomer;
pyrolyzing the obtained polymer composition at a pyrolysis temperature, thereby substantially removing the solvent and pyrolyzing the polymer, obtaining a carbon material; and
optionally activating the carbon material at an activation temperature, thereby increasing the surface area and pore volume to a desired level to yield porous carbon materials 5 and 7. The curing is done at elevated temperature, for example around 95° C.

TABLE 1
Properties of the catalysts (porous carbon materials)

| | | | | | Total | Total | Micro- | Meso- | | | |
|---|---|---|---|---|---|---|---|---|---|---|---|
| | | | BET | Total | micro- | meso- | pore | pore | | | |
| | | | surface | pore | pore | pore | volume:Total | volume:Total | Total | NLDFT | NLDFT |
| | | | area | volume | volume | volume | Pore | Pore | NLDFT | SSA < | SSA > |
| No. | Description | Type | (m²/g) | (ml/g) | (ml/g) | (ml/g) | Volume | Volume | SSA | 20 Å | 20 Å |
| 7 | Pyrolised | Inventive | 607 | 0.72 | 0.19 | 0.52 | 0.26 | 0.72 | 861 | 773 | 88 |
| | carbon | | | | | | | | | | |
| | aerogel 5 | | | | | | | | | | |
| 5 | Pyrolised | Inventive | 727 | 0.89 | 0.22 | 0.66 | 0.25 | 0.74 | 790 | 669 | 121 |
| | carbon | | | | | | | | | | |
| | aerogel 3 | | | | | | | | | | |

### Comparative Example 1: Production of Phosgene not According to the Present Invention

A reaction tube with an internal diameter of 39.3 mm and a length of 2 m was filled with 4 mm activated carbon extrudates from Donau Carbon. A feed comprising CO and Cl₂ corresponding to a loading of 3 kg phosgene/m²s with a molar CO excess of 5% was fed to the reaction tube in a system for producing phosgene operating at 4 barg inlet pressure. The reaction tube was cooled with mono-chlorobenzene at temperature of 80° C. The conversion of chlorine was about 97.6%. The temperature distribution in the reaction tube was measured using a multipoint thermocouple. The hot-spot temperature was of about 590° C. The temperature profile in the tube is shown in FIG. 1. The concentration of CCl₄ at the outlet of the reaction tube (measured by online GC) was about 83 vol-ppm.

### Example 1: Production of Phosgene According to the Present Invention

For producing phosgene according to Example 1, the system and process for producing phosgene of Comparative Example 1 was used, except that a portion of the product gas stream obtained at the outlet end of the reaction tube was recycled, this portion (GR) corresponded to 45% of the amount of the initial feed gas stream. The recycling comprises sucking in and mixing this portion by an ejector in the feed stream. The ejector was located upstream of the inlet end of the reaction tube (f(GR):f(G2)=0.45:1 and f(GR):f(GP)=0.31:1). The system for producing phosgene was represented schematically in FIG. 2. The hot-spot temperature drops to 407° C. compared to the hot-spot obtained with the process of Comparative Example 1 and the chlorine conversion was of 93.7%. The temperature profile in the tube is shown in FIG. 1. The CCl₄ concentration at the outlet end of the reaction tube was below the detection limit of 1 vol-ppm.

A typical production unit for carrying out the process of Example 1 is illustrated in FIG. 2a (the 93.7% chlorine conversion is obtained after passing in the reaction zone Z1).

### Example 2: Production of Phosgene According to the Present Invention

For producing phosgene according to Example 2, the system and process for producing phosgene of Example 1 was used, except the activated carbon catalyst from Donau Carbon was replaced by an activated carbon catalyst prepared as in Reference Example 1 and that a larger portion was recycled corresponding to 62% of the amount of the initial feed gas stream for controlling the hot-spot temperature which was of 408° C. which is comparable to the hot-spot obtained with Example 1 (f(GR):f(G2)=0.62:1 and f(GR):f(GP)=0.383:1). The recycling comprises sucking in and mixing this portion by an ejector in the feed stream. The ejector was located upstream of the inlet end of the reaction tube. The chlorine conversion increases compared to the process of Comparative Example 1 and was of 98.9%. The temperature profile in the tube is shown in FIG. 1. The CCl₄ concentration at the outlet end of the reactor remains below the detection limit of 1 vol-ppm.

The temperature profile obtained for Comparative Example 1, Examples 1 and 2 are shown in FIG. 1.

### Example 3: Production of Phosgene According to the Present Invention

The process of Example 3 produced 39 t/h of phosgene. The corresponding feed streams (28 t/h chlorine and 11.6 t/h CO) had a pre-pressure of 8 bara and were initially used as a driving jet in an ejector. This means that approximately 241 t/h of the reaction gases at 4 bara were sucked in from the outlet end of an uncooled fixed bed (adiabatic fixed-bed reactor) with a diameter of 4.7 m and a length of about 3.6 m filled with 4 mm of activated carbon extrudates (from Donau Carbon) and cooled in a heat exchanger so that the inlet temperature of the gas mixture of the feed gas and the recirculated product gas was of about 75° C. and compressed to 4.5 bara by the ejector. The chlorine conversion was of about 95%, with the gas being heated adiabatically to only 300° C. (hot spot temperature). The temperature distribution in the uncooled fixed bed was measured using a multi-thermocouple. The non-recirculated part of the product gas was fed to a cooled post-reactor downstream of the uncooled fixed bed, where the complete conversion of chlorine was achieved. A schematic picture of the production unit used in Example 3 is shown in FIG. 4.

For the process of Example 3, f(GR):f(G2)=241 t/h: (28+11.6) t/h=241: 39.6=6:1 and f(GR):f(GP)=241 t/h: (241+39.6) t/h=0.86:1

### Example 4: Production of Phosgene According to the Present Invention

On a large scale, it was implemented as follows. A standard cooled reactor (fixed bed—2849 pipes—internal pipes diameter: 39.3 mm—filled pipe length: 3.8 m—4 mm of activated carbon extrudates—catalyst 7 or 5 as described in Reference Example 1) was used and the necessary amount of phosgene was brought to upstream of the reactor for dilution via an external return pipe with a diameter of 200 mm and an ejector driven by the fresh feed comprising a mixture of Cl₂ and CO in excess (10%). After intensive mixing in a static mixer, the total gas flow goes to the reactor.

TABLE 2

| | | Example 4 |
|---|---|---|
| Cl₂ feed gas stream | kg/h | 26767.9 |
| CO feed gas stream | kg/h | 11612 |
| Phosgene flow | kg/h | 35500 |
| CO excess | % | 10 |
| Inlet gas temp. | ° C. | 62 |
| Inlet gas pressure | bara | 4.9 |
| Coolant inlet temp. | ° C. | 75 |
| Coolant outlet temp. | ° C. | 86 |

### Comparative Example 2: Production of Phosgene not According to the Present Invention

A reaction tube with an internal diameter of 39.3 mm and a length of 2 m was filled with 4 mm activated carbon catalyst other than the one used for the examples and comparative example herein above. A feed of CO (9.4 kg/h) and of Cl₂ (4.1 kg/h)—a molar CO excess of 10%—was fed to the reaction tube in a system for producing phosgene operating at 3.7 barg (bar gauge) inlet pressure. The reaction tube was cooled with mono-chlorobenzene at temperature of 80° C. The conversion of chlorine was about 96.6%. The temperature distribution in the reaction tube was measured using a multipoint thermocouple. The hot-spot temperature was of about 562° C. The temperature profile in the tube is shown in FIG. 7. The concentration of CCl₄ at the outlet of the reaction tube (measured by online GC) was about 24 vol-ppm.

### Comparative Example 3: Production of Phosgene not According to the Present Invention

For producing phosgene according to Comparative Example 3, the system and process for producing phosgene of Comparative Example 2 was used, except that the product gas stream obtained at the outlet end of the reaction tube is cooled down and partially condensate in a downstream condenser as described in U.S. 2011/0319662. The condenser is running at −10° C. and 3.5 barg. From the condenser offgas, 5 kg/h were taken and recycled back and mixed with the reactor feed streams prior to entering the inlet of the reactor. The recycled gas stream contained 89.2 mol.-% CO and 10.8 mol.-% COCl₂, a composition different to the gas stream exiting the reactor. The temperature distribution in the reaction tube was measured using a multipoint thermocouple. The hot-spot temperature was of about 466° C., thus reduced compared to the hot-spot temperature obtained in Comparative Example due to the dilution of the feed streams. The temperature profile in the tube is shown in FIG. 7. The conversion of chlorine was about 99.1%. The concentration of CCl₄ at the outlet of the reaction tube (measured by online GC) was about<1 vol-ppm.

### Example 5: Production of Phosgene According to the Present Invention

For producing phosgene according to Example 5, the system and process for producing phosgene of Comparative Example 2 was used, except that a portion (GR) of the product gas stream (GP) obtained at the outlet end of the reaction tube was recycled and mixed with the reactor feed streams prior to entering the inlet of the reactor. The recycled gas stream (GR) contained 9.1 mol.-% CO and 90.9 mol.-% COCl₂, the same composition as the gas stream (GP). The hot-spot temperature drops to 428° C. compared to the hot-spot obtained with the process of Comparative Example 2 without any recycling and with the process of Comparative Example 3 with a different recycling. The chlorine conversion was of 93%. The temperature profile in the tube is shown in FIG. 7. The CCl₄ concentration at the outlet end of the reaction tube was below the detection limit of 1 vol-ppm.

For the process of Example 5, f(GR)=5 kg/h; f(G2)=13.5 kg/h; f(GR):f(G2)=0.37:1 and f(GR):f(GP)=5: (5+13.5) kg/h=0.27:1

The temperature profile obtained for Comparative Examples 2 and 3 and Example 5 are shown in FIG. 7. It results that the process according to the present invention is better compared to the processes of Comparative Examples 2 and 3 as compared to Comparative Example 2, the hot-spot temperature is greatly decreased and concentration of CCl₄ at the outlet of the reaction tube is greatly reduced and compared to Comparative Example 3 there is no need to cool down the stream which is recycled to −10° C. which permits to save energy and thus reduce costs.

### DESCRIPTION OF THE FIGURES

FIG. 1a: represents the temperature profile obtained when preparing phosgene with the process of Comparative Example 1 and the process of Example 1.

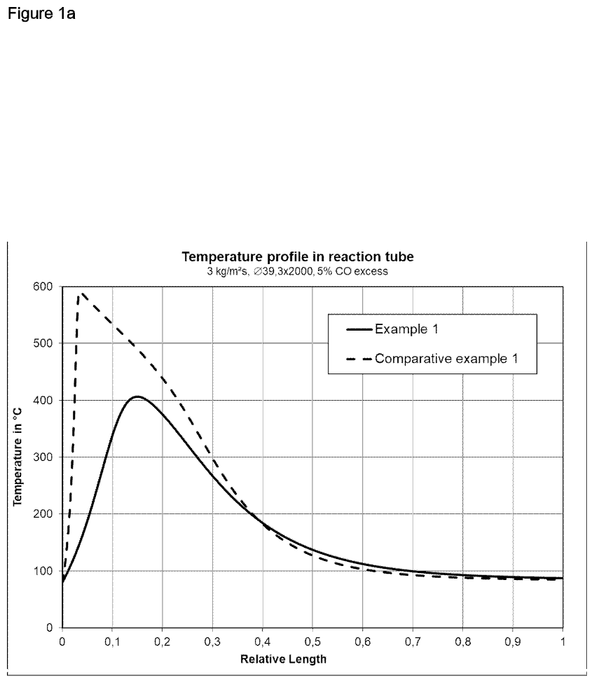

FIG. 1b: represents the temperature profile obtained when preparing phosgene with the processes of Example 1 and Example 2.

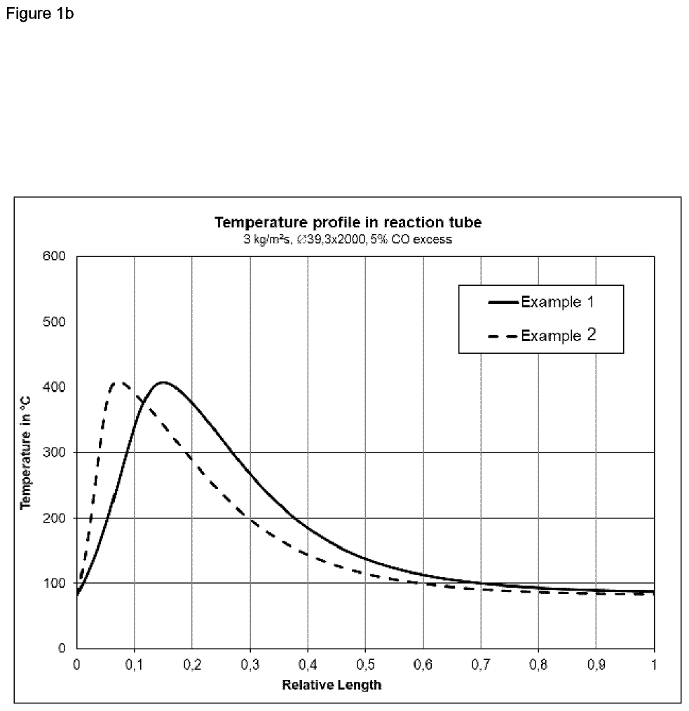

FIG. 2a: is a schematic representation of a production unit according to embodiments of the invention. The production unit comprises a reaction zone Z1 comprising an inlet means, such as a pipe, for passing the gas stream G1 into Z1 and a reaction means, a cooled reactor, for bringing into contact the gas stream G1 with a catalyst C1, preferably a carbon containing catalyst not represented on the figure. The cooled reactor is a tubular reactor comprising one or more tubes, preferably more than one tube, preferably a cooled tube-bundle reactor. Such reactor is cooled with a heat transfer/coolant medium, preferably monochlorobenzene. The coolant medium inlet temperature can range between 60 and 100° C. The maximum gas stream temperature in the reactor was set to 400° C.(hot-spot). Further, the reaction zone Z1 comprises an outlet means, for example a pipe, for removing the gas stream GP from Z1. The gas stream GP comprises phosgene and one or more of carbon monoxide and chlorine. At the outlet end of the reaction Z1, 90-100% of chlorine is converted. The production unit further comprises a stream dividing device for dividing the gas stream GP in two streams, a gas stream GR and a gas stream G2, a means, such as a pipe, for passing the gas stream GP into the stream dividing device not represented in this figure. The gas streams G2 and GR have respectively the same chemical composition as GP. The temperature of the gas stream GP, GR and G2 was of 80±5° C. Such temperature could range from 60 to 100° C. The production unit further comprises a means E, preferably an ejector, for admixing the gas stream G0 (G0(1)+G0(2)) with the gas stream GR comprising an inlet means, such as a pipe, for feeding the gas stream G0 into E and a means for feeding the gas stream GR into E. The gas stream G0 consists of CO and Cl₂, with 5% excess of CO. The gas streams G0(1) and G0(2) not represented on the figure were mixed in a static mixer upstream of the ejector E. The recycle ratio is the ratio of the mass flow f(GR) of the gas stream GR relative to the mass flow f(GP) of the gas stream GP, f(GR):f(GP), which is in the range of from 0.2:1 to 0.8:1, preferably in the range of from 0.3:1 to 0.7:1, more preferably in the range of from 0.35:1 to 0.6:1. The production unit further comprises a return means R, a return pipe, for passing the gas stream GR exiting from the stream dividing device to said means E. The phosgene is produced at a surface load of 3 kg/m²s.

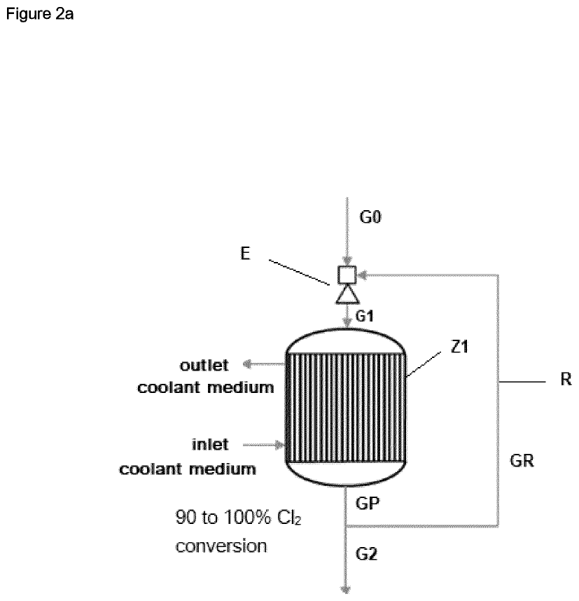

FIG. 2b: is a schematic representation of a production unit according to embodiments of the invention. The production unit of FIG. 2b comprises the components of FIG. 2a, except that for preparing G1, G0(1) (CO gas stream) drives the ejector E wherein the gas stream GR is admixed and G0(2) is combined downstream of the ejector E.

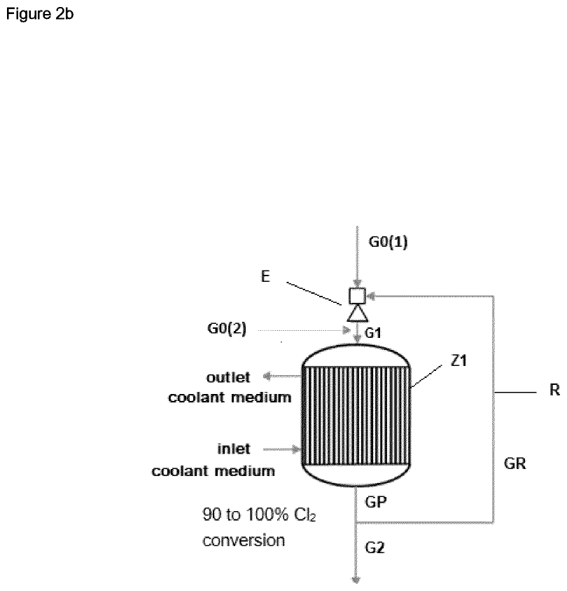

FIG. 3: is a schematic representation of a production unit according to embodiments of the invention. The production unit of FIG. 3 comprises the components of FIG. 2 and further comprises a reaction zone Z2 comprising an inlet means, such as a pipe, for passing the gas stream G2 into Z2. The reaction zone Z2 comprises a reaction means, preferably a cooled reactor, for bringing into contact the gas stream G1 with a catalyst C2, preferably a carbon containing catalyst, and an outlet means, such as a pipe, for removing the gas stream GF from Z2. The cooled reactor is a tubular reactor comprising one or more tubes, preferably more than one tube, more preferably a cooled tube-bundle reactor. Such reactor is cooled with a heat transfer/coolant medium, preferably monochlorobenzene. Alternatively, an adiabatic fixed-bed can be used in the reaction zone Z2 as the reaction means. The gas stream GF comprises phosgene. At the outlet end of the reaction zone Z2, more than 99.5% of chlorine was converted. The phosgene is produced at a surface load of about 3 kg/m²s.

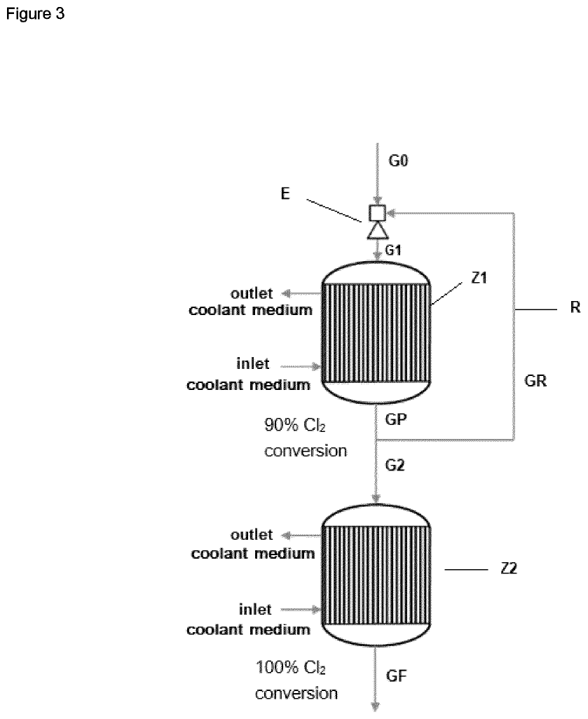

FIG. 4: is a schematic representation of a production unit according to embodiments of the invention. The production unit comprises a reaction zone Z1 comprising an inlet means, such as a pipe, for passing the gas stream G1 into Z1 and a reaction means, an uncooled reactor, for bringing into contact the gas stream G1 with a catalyst C1, preferably a carbon containing catalyst not represented on the figure. The gas stream G1 has a temperature of 75° C. The uncooled reactor is an adiabatic fixed-bed reactor. The reactor has a diameter of 4.7 m and a length of 3.6 m and was filled with 4mm carbon extrudates (from DONAU CARBON). The maximum gas stream temperature in the reactor was of about 300° C.(hot-spot). Further, the reaction zone Z1 comprises an outlet means, for example a pipe, for removing the gas stream GP from Z1. The gas stream GP comprises phosgene and one or more of carbon monoxide and chlorine. At the outlet end of the reaction Z1, 95% of chlorine is converted. The production unit further comprises a stream dividing device S for dividing the gas stream GP in two streams, a gas stream GR and a gas stream G2, a means, such as a pipe, for passing the gas stream GP into S. The gas streams G2 and GR have respectively the same chemical composition as GP. The temperature of the gas stream GP, GR and G2 was of 300° C. The production unit further comprises a means E, preferably an ejector, for admixing the gas stream G0 and the gas stream GR comprising an inlet means, such as a pipe, for feeding the gas stream G0 (G0(1)+G0(2)) into E and a return means for feeding the gas stream GR into E. The gas stream G0 consists of CO and Cl₂ and has a pressure P0 of 8 bara. The recycle ratio is the ratio of the mass flow f(GR) of the gas stream GR relative to the mass flow f(GP) of the gas stream GP, f(GR):f(GP), which can in the range of from 0.20:1 to 0.95:1, preferably in the range of from 0.50:1 to 0.92:1, more preferably in the range of from 0.70:1 to 0.90:1. In the present case, f(GR):f(GP)=0.86:1. The production unit further comprises a return means R, a return pipe, for passing the gas stream GR exiting from the stream dividing device to said means E and a heat exchanger H. Said return pipe R is cut in two pipes R1 and R2, a pipe R1 exiting the device S toward the heat exchanger H and a pipe R2 exiting said heat exchanger toward an inlet end of the means E. The gas stream GR has a pressure PR of about 4 bara. The temperature of the gas stream G1 is of about 75° C. and the gas stream G1 has a pressure of 4.5 bara. The production unit further comprises a reaction zone Z2 downstream of the device S. Said zone, not shown in this figure, comprises an inlet means, such as a pipe, for passing the gas stream G2 into Z2. The reaction zone Z2 comprises a reaction means, a cooled reactor, for bringing into contact the gas stream G1 with a catalyst C2, preferably a carbon containing catalyst, and an outlet means, such as a pipe, for removing the gas stream GF from Z2. The cooled reactor is a tubular reactor comprising one or more tubes, preferably more than one tube, more preferably a cooled tube-bundle reactor. Such reactor is cooled with a heat transfer medium, preferably mono-chlorobenzene. The gas stream GF comprises phosgene. At the outlet end of the reaction zone Z2, 100% of chlorine is converted. The phosgene is produced at a load of 39 t/h.

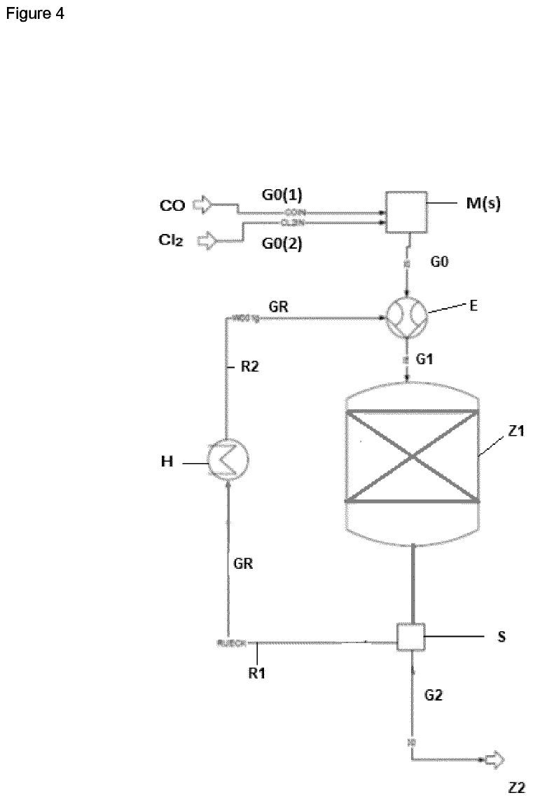

FIG. 5: is a schematic representation of a production unit according to embodiments of the invention. The production unit comprises a reaction zone Z1 comprising an inlet means for passing the gas stream G1 into Z1 and a reaction means, an uncooled reactor R1, for bringing into contact the gas stream G1 with a catalyst C1, preferably a carbon containing catalyst not represented on the figure. The adiabatic bed has a diameter of 4.7 m, a length of 3.6 m and is filled with 4 mm carbon extrudates. The maximum gas stream temperature in the reactor was of at most 400° C.(hot-spot), preferably 300° C. Further, the reaction zone Z1 comprises an outlet means for removing the gas stream GP from Z1. The gas stream GP comprises phosgene and one or more of carbon monoxide and chlorine. The gas stream GP is directly fed into a cooling means, multiple cooling tubes C which are cooled with a coolant medium, such as monochlorobenzene. At the outlet end of said cooling tubes C, a stream dividing device, not shown in the figure, divides the “cooled” gas stream GP in two streams, a gas stream GR and a gas stream G2. The gas streams G2 and GR have respectively the same chemical composition as GP. The temperature of the gas stream GP, GR and G2 was of about 75° C. The production unit further comprises a means E, preferably an ejector, for admixing the gas stream G0 (G0(1)+G0(2)) and the gas stream GR comprising an inlet means, such as a pipe, for feeding the gas stream G0 into E and a means for feeding the gas stream GR into E. The means E, the reactor R1, the multiple tubes C, all are in one housing. The gas stream G0 consists of CO and Cl₂. The flow rate ratio of the gas stream GR to the gas stream GP is the range of from 0.2:1 to 0.909:1, preferably in the range of from 0.3:1 to 0.7:1, more preferably in the range of from 0.35:1 to 0.6:1. The production unit further comprises a reaction zone Z2. Said zone, not shown in this figure, comprises an inlet means, such as a pipe, for passing the gas stream G2 into Z2. The reaction zone Z2 comprises a reaction means, a cooled reactor, for bringing into contact the gas stream G1 with a catalyst C2, preferably a carbon containing catalyst, and an outlet means, such as a pipe, for removing the gas stream GF from Z2. The cooled reactor is a tubular reactor comprising one or more tubes, preferably more than one tube, more preferably a cooled tube-bundle reactor. Such reactor is cooled with a coolant medium, preferably mono-chlorobenzene. The gas stream GF comprises phosgene. At the outlet end of the reaction zone Z2, 100% of chlorine was converted.

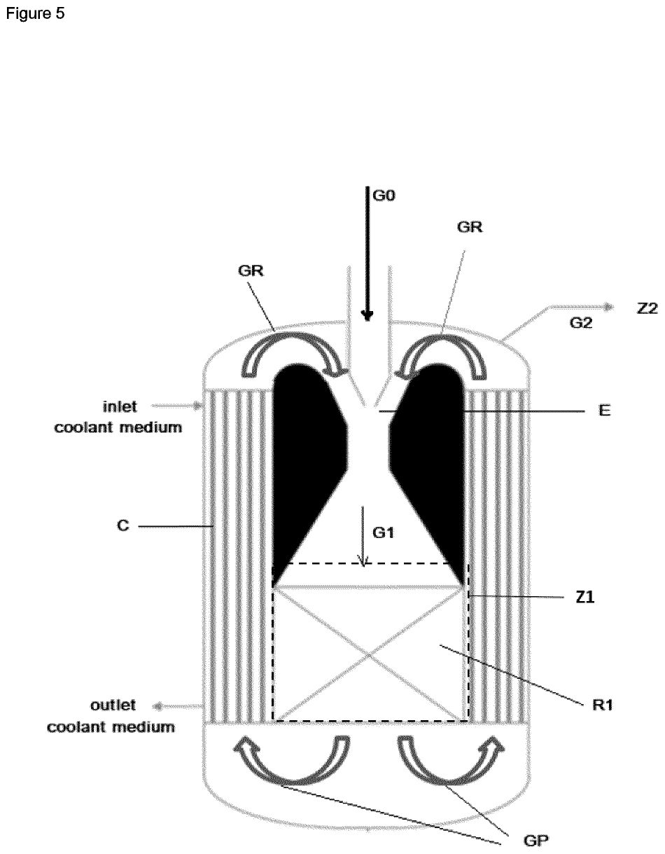

FIG. 6: is a schematic representation of a production unit according to embodiments of the invention. The production unit of said Figure is as the one of FIG. 2a, except that the cooled reactor comprise a different cooling system, namely with two cooling zones. On the Figure, L represents the length of the cooled tubes of the reactor, L1 represents the length of the first cooling zone of the reactor which runs at higher temperatures and L2 represents the length of the second cooling zone of the reactor for the final cooling. It is preferred that 1 m≤L2≤1.5 m, more preferably L2=1.3 m. Further, a represents the inlet of the coolant medium used in the first cooling zone, b represents the outlet of the coolant medium used in the first cooling zone, c represents the inlet of the coolant medium used in the second cooling zone, d represents the outlet of the coolant medium used in the second cooling zone. It is believed that this configuration with two zones will permit to save the heat generation which took place in the reaction zone Z1 for production of high worthy steam. The first cooling zone can be for example running on an temperature range of from 200 to 300° C., preferred about 250° C. With a heat transfer oil passing in the first cooling zone, the heat produced from the reaction of the catalyst C1 in a reactor of the reaction zone Z1 could then be removed from the reactor of the reaction zone Z1. The oil recovered from the first cooling zone can thus serve to heat a solvent (such as water) in a other heat exchanger (outside of the production unit for preparing phosgene). The second cooling zone can be running under normal conditions, namely at about 80° C. A reactor with more than one cooling zone can be such as described in WO 03/072237 A1.

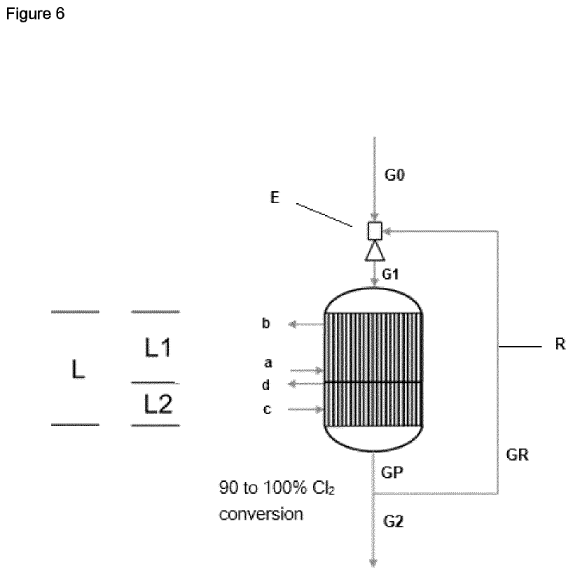

FIG. 7: represents the temperature profile obtained when preparing phosgene with the process of Comparative Examples 2 and 3 and with the process of Example 5.

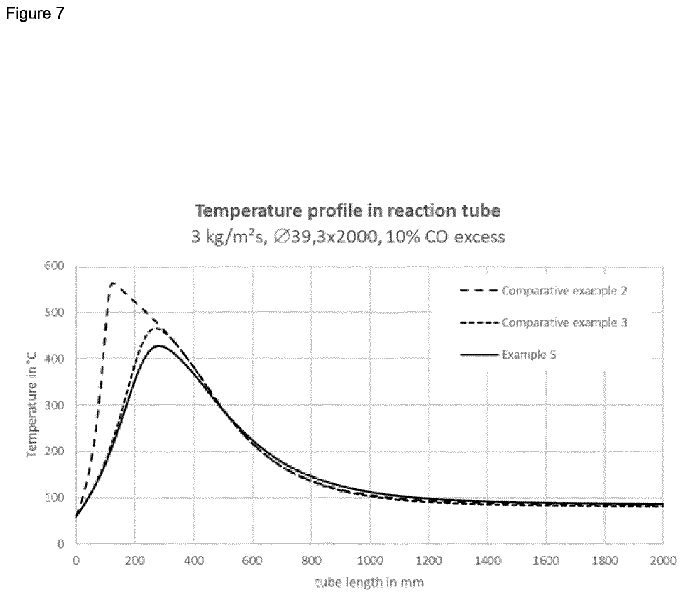

### CITED LITERATURE

Christopher J. Mitchell et al., Selection of carbon catalysts for the industrial manufacture of phosgene, Hunstman Polyurethanes, Catal. Sci. Technol., 2012, 2109-2115
WO 2012/092210 A1
Ullmann's Encyclopedia of industrial chemistry, Chapter, Phosgene” 5^{th} Ed. Vol. A 19, p 413 ff., VCH Verlagsgesellschaft mbH, Weinheim, 1991
WO 03/072237 A1
DE 10110847 A1

1.-17. (canceled)

18. A continuous process for preparing phosgene, comprising
(i) providing a gas stream G1 comprising carbon monoxide (CO) and chlorine (Cl₂);
(ii) passing the gas stream G1 into a reaction zone Z1, bringing the gas stream G1 into contact with a catalyst C1 comprised in said reaction zone Z1, obtaining a gas stream GP comprising phosgene and one or more of carbon monoxide and chlorine, and removing the gas stream GP from said reaction zone Z1;
(iii) dividing the gas stream GP, obtaining at least two gas streams comprising a gas stream G2 and a gas stream GR, G2 and GR having the same chemical composition as GP,
wherein the ratio of the mass flow f(GR) of the gas stream GR relative to the mass flow f(G2) of the gas stream G2, f(GR):f(G2), is in the range of from 0.1:1 to 20:1;
wherein during standard operation mode of the continuous process, providing the gas stream G1 according to (i) comprises
preparing G1 as a mixture comprising at least two gas streams, said at least two streams comprising the gas stream GR and j gas streams G0(k) with k=1, . . . j, wherein the j gas streams G0(k) in total comprise carbon monoxide (CO) and chlorine (Cl₂) and wherein j is in the range of from 1 to 3.

19. The process of claim 18, wherein j is 1 or 2.

20. The process of claim 18, wherein f(GR):f(G2) is in the range of from 0.2:1 to 10:1.

21. The process of claim 18, wherein during standard operation mode of the continuous process, providing the gas stream G1 according to (i) comprises preparing G1 as a mixture comprising, three gas streams, said three gas streams being the gas stream GR and two gas streams G0(1) and G0(2), wherein the two gas streams G0(1) and G0(2) in total comprise carbon monoxide (CO) and chlorine (Cl₂).

22. The process of claim 18, wherein during standard operation mode of the continuous process, providing the gas stream G1 according to (i) comprises
preparing G1, as a mixture comprising three gas streams GR, G0(1) and G0(2), G0(1) comprising carbon monoxide (CO) and G0(2) comprises chlorine (Cl₂), which comprises
combining the gas stream G0(1) with the gas stream G0(2) and
admixing the gas stream GR with the combined gas streams G0(1) and G0(2).

23. The process of claim 22, wherein admixing the gas stream GR with the combined two gas streams G0(1) and G0(2) according to (i) is performed in a mixing device, wherein the mixing device is an ejector, a static mixer or a dynamic mixer.

24. The process of claim 22, wherein the mole ratio of the amount of chlorine, in mol, to the amount of carbon monoxide, in mol, in the combined gas streams G0(1) and G0(2) is in the range of from 0.6:1 to 0.999:.

25. The process of claim 18, wherein during standard operation mode of the continuous process, providing the gas stream G1 according to (i) comprises
preparing G1, as a mixture comprising three gas streams GR, G0(1) and G0(2), G0(1) comprising carbon monoxide (CO) and G0(2) comprises chlorine (Cl₂), which comprises
admixing the gas stream G0(1) with the gas stream GR, and
combining the gas stream G0(2) with the admixed gas streams G0(1) and GR.

26. The process of claim 18, wherein during standard operation mode of the continuous process, providing the gas stream G1 according to (i) comprises
preparing G1, as a mixture comprising three gas streams GR, G0(1) and G0(2), G0(1) comprising carbon monoxide (CO) and G0(2) comprises chlorine (Cl₂), which comprises
admixing the gas stream G0(2) with the gas stream GR, and
combining the gas stream G0(1) with the admixed gas streams G0(2) and GR.

27. The process of claim 18, wherein the reaction zone Z1 comprises a reactor comprising the catalyst C1, wherein the reactor is a tubular reactor comprising one or more tubes, the catalyst C1 being filled in said one or more tubes.

28. The process of claim 27, wherein the gas stream in the reactor is of at most 450° C. the temperature being measured with a multipoint thermocouple.

29. The process of claim 18, further comprising,
after (iii), passing the gas stream GR through a return means R prior to preparing G1 as a mixture comprising at least two streams according to (i), during standard operation mode of the continuous process, in an ejector.

30. The process of claim 18, wherein the catalyst C1 is a carbon catalyst.

31. The process of claim 30, wherein the catalyst C1 comprises a porous material comprising carbon, micropores and mesopores, wherein said micropores have a pore diameter, determined according to DIN 66135-2, of less than 2 nm and wherein said mesopores have a pore diameter, determined according to DIN 66134, in the range of from 2 to 50 nm,
wherein the volume of the mesopores of the porous material, determined according to dual-isotherm Nonlocal Density Functional Theoretical (NLDFT) Advanced Pore Size Distribution (PSD) technique, is of at least 0.45 ml/g.

32. The process of claim 18, further comprising
(iv) passing the stream G2 into a reaction zone Z2, bringing the gas stream G2 into contact with a catalyst C2 comprised in said reaction zone Z2, obtaining a gas stream GF comprising phosgene, and removing the gas stream GF from said reaction zone Z2.

33. A production unit for carrying out the process according to claim 18, the unit comprising
a reaction zone Z1 comprising
an inlet means for passing the gas stream G1 into Z1;
a catalyst C1;
a reaction means for bringing into contact the gas stream G1 with said catalyst C1;
an outlet means for removing the gas stream GP from Z1;
a stream dividing device S for dividing the gas stream GP in at least two streams comprising a gas stream GR and a gas stream G2;
a means for passing the gas stream GP into said device S;
at least one means M for preparing G1 as a mixture comprising at least two streams;
a return means R for passing the gas stream GR exiting from S to said means M for preparing G1.

34. Use of the production unit according to claim 33 for the continuous production of phosgene.
